(19) United States
(12) Patent Application Publication
(10) Pub. No.: US 2019/0304042 A1
(43) Pub. Date: Oct. 3, 2019

(54) INTERNET-BASED CRIMINAL INVESTIGATION

(71) Applicant: Captis Intelligence, Inc., Valencia, CA (US)

(72) Inventors: Daniel Santell, Valencia, CA (US); Dario Brebric, Valencia, CA (US); Rajiv Sanghavi, Valencia, CA (US)

(21) Appl. No.: 15/941,989

(22) Filed: Mar. 30, 2018

(51) Int. Cl. G06Q 50/26; G06Q 50/00

(52) U.S. Cl. CPC G06Q 50/26; G06F 3/0481; G06Q 50/01

(57) ABSTRACT

A method of supporting a criminal investigation includes receiving crime posting data generated by user interaction with a first user interface, the first user interface accessible via a web browser or mobile application, updating a second user interface to display a new crime posting based on the crime posting data, the second user interface accessible via a web browser or mobile application, and receiving tip data generated by user interaction with the second user interface, the tip data including a reference to the new crime posting. The method further includes generating a unique tip identifier and storing the tip identifier in association with the tip data.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to criminal investigation, and more particularly, to the generation and management of anonymous tips in support of a criminal investigation.

### 2. Related Art

Despite the prevalence of surveillance cameras, e.g. at entry points of businesses and residences, many crimes remain unsolved. In many instances, for example, the perpetrator of the burglary, robbery, assault, or other crime is never identified, even when his/her face or other distinguishing features are captured on camera.

### BRIEF SUMMARY

The present disclosure contemplates various systems, methods, and apparatuses for overcoming the above drawbacks accompanying the related art. One aspect of the embodiments of the present disclosure is a non-transitory program storage medium on which are stored instructions executable by a processor or programmable circuit to perform operations for supporting a criminal investigation. The operations may include receiving crime posting data generated by user interaction with a first user interface, the first user interface accessible via a web browser or mobile application, updating a second user interface to display a new crime posting based on the crime posting data, the second user interface accessible via a web browser or mobile application, and receiving tip data generated by user interaction with the second user interface, the tip data including a reference to the new crime posting. The operations may further include generating a unique tip identifier and storing the tip identifier in association with the tip data.

The operations may further include updating a third user interface to display an anonymous tip based on the tip data, the third user interface accessible via a web browser or mobile application, receiving tip status data generated by user interaction with the third user interface, and storing the tip status data in association with the tip identifier. The operations may further include receiving a tip status request generated by user interaction with the second user interface, the tip status request including the tip identifier, and updating the second user interface to display a tip status based on the tip status data stored in association with the tip identifier included in the tip status request. The operations may further include receiving a designation command generated by user interaction with the first user interface, the designation command designating a tip investigator associated with the crime posting data. Access to the third user interface may be limited to the tip investigator by secure login.

The second user interface may include a social media share button by which one or more content items of the new crime posting may be shared on social media by user interaction with the second user interface. The first user interface may display social media interaction information in relation to the new crime posting.

The crime posting data may include location data and the second user interface may include an interactive map by which crime postings may be browsed by location.

The second user interface may include a search feature for viewing a subset of crime postings satisfying criteria specified by user interaction with the second user interface. The second user interface may display, for each crime posting of the subset of crime postings, a summary including only a limited set of information about the crime posting, each of the summaries selectable by user interaction with the second user interface to allow viewing of a complete set of information about the crime posting. For each crime posting of the subset of crime postings, the second user interface may include a social media share button by which one or more content items of the crime posting may be shared on social media by user interaction with the second user interface, each of the social media share buttons being usable while the corresponding summary is displayed and the complete set of information about the corresponding crime posting is not displayed. For each crime posting of the subset of crime postings, the second user interface may include a view crime video button by which a crime video of the crime posting may be viewed by user interaction with the second user interface, each of the view crime video buttons being usable while the corresponding summary is displayed and the complete set of information about the corresponding crime posting is not displayed.

Access to the first user interface may be limited to a registered user by secure login. The first user interface may include a list of locations associated with the registered user, each of the locations selectable by user interaction with the first user interface to allow viewing of a subset of crime postings associated with the location.

Access to the second user interface may be open to unregistered users.

Another aspect of the embodiments of the present disclosure is a method of supporting a criminal investigation. The method may include receiving crime posting data generated by user interaction with a first user interface, the first user interface accessible via a web browser or mobile application, updating a second user interface to display a new crime posting based on the crime posting data, the second user interface accessible via a web browser or mobile application, and receiving tip data generated by user interaction with the second user interface, the tip data including a reference to the new crime posting. The method may further include generating a unique tip identifier and storing the tip identifier in association with the tip data.

The method may further include updating a third user interface to display an anonymous tip based on the tip data, the third user interface accessible via a web browser or mobile application, receiving tip status data generated by user interaction with the third user interface, and storing the tip status data in association with the tip identifier. The method may further include receiving a tip status request generated by user interaction with the second user interface, the tip status request including the tip identifier and updating the second user interface to display a tip status based on the tip status data stored in association with the tip identifier included in the tip status request.

Another aspect of the embodiments of the present disclosure is a system for supporting a criminal investigation. The system may include a crime poster input interface for receiving crime posting data generated by user interaction with a first user interface, the first user interface accessible via a web browser or mobile application, a server for updating a second user interface to display a new crime posting based on the crime posting data, the second user interface accessible via a web browser or mobile application, and a tipster input interface for receiving tip data generated by user interaction with the second user interface, the tip data including a reference to the new crime posting. The server may generate a unique tip identifier and store the tip identifier in association with the tip data.

The server may update a third user interface to display an anonymous tip based on the tip data, the third user interface accessible via a web browser or mobile application. The system may further include a tip investigator input interface for receiving tip status data generated by user interaction with the third user interface. The server may store the tip status data in association with the tip identifier. The tipster input interface may receive a tip status request generated by user interaction with the second user interface, the tip status request including the tip identifier, and update the second user interface to display a tip status based on the tip status data stored in association with the tip identifier included in the tip status request.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an overview of a system for supporting a criminal investigation according to an embodiment of the present disclosure;

FIG. 2 shows an example crime details page of a crime poster user interface (UI);

FIGS. 3A-3E show an example series of crime upload pages of the crime poster UI, with FIG. 3A showing a crime details data entry section, FIG. 3B showing a suspect information data entry section, FIG. 3C showing a reward information data entry section, FIG. 3D showing a verification page, and FIG. 3E showing a status notification page;

FIG. 4 shows an example tip management page of the crime poster UI;

FIG. 5 shows an example homepage of a tipster UI;

FIG. 6 shows an example search page of the tipster UI;

FIG. 7 shows an example criminal investigation apparatus according to an embodiment of the present disclosure;

FIG. 8 shows example contents of a tip data storage;

FIG. 9 shows an example operational flow according to an embodiment of the present disclosure;

FIG. 10 shows an example enterprise dashboard of the crime poster UI;

FIG. 11 shows an example enterprise incidents page of the crime poster UI; and

FIG. 12 shows an example of a computer in which the criminal investigation apparatus of FIGS. 1 and 7, the operational flow of FIG. 9, and/or other embodiments of the disclosure may be wholly or partly embodied.

### DETAILED DESCRIPTION

The present disclosure encompasses various embodiments of systems, methods, and apparatuses for supporting a criminal investigation. The detailed description set forth below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

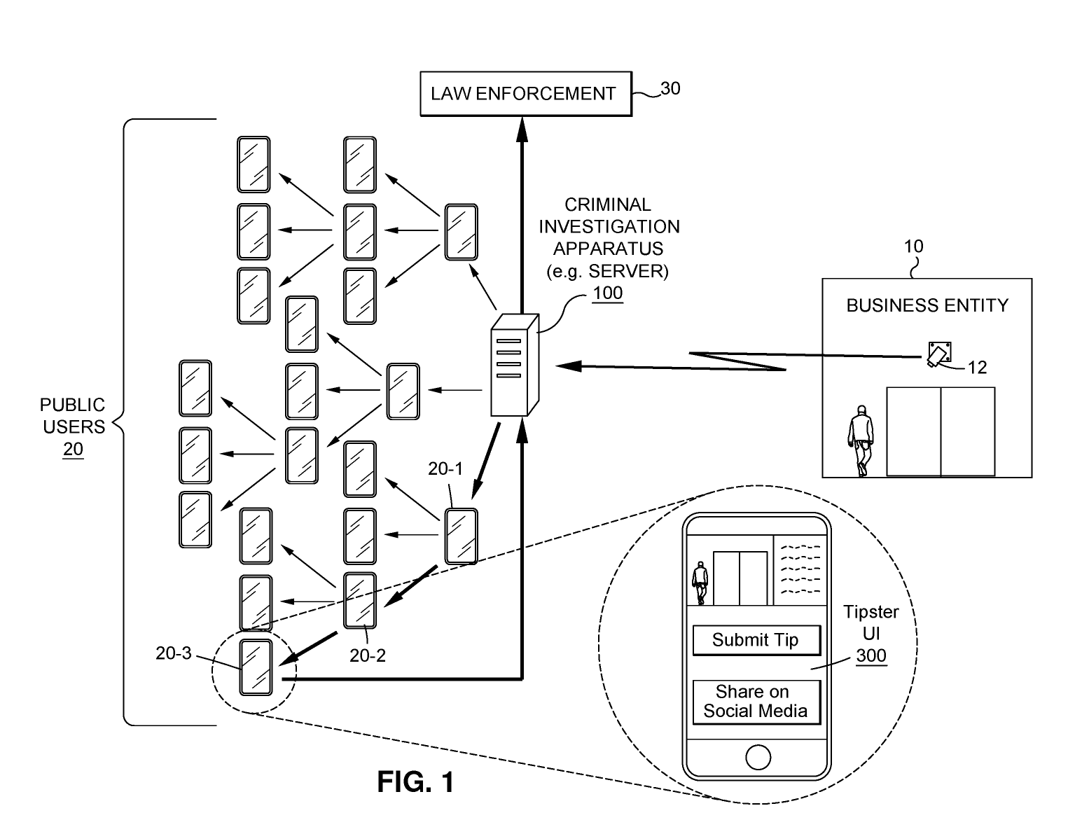

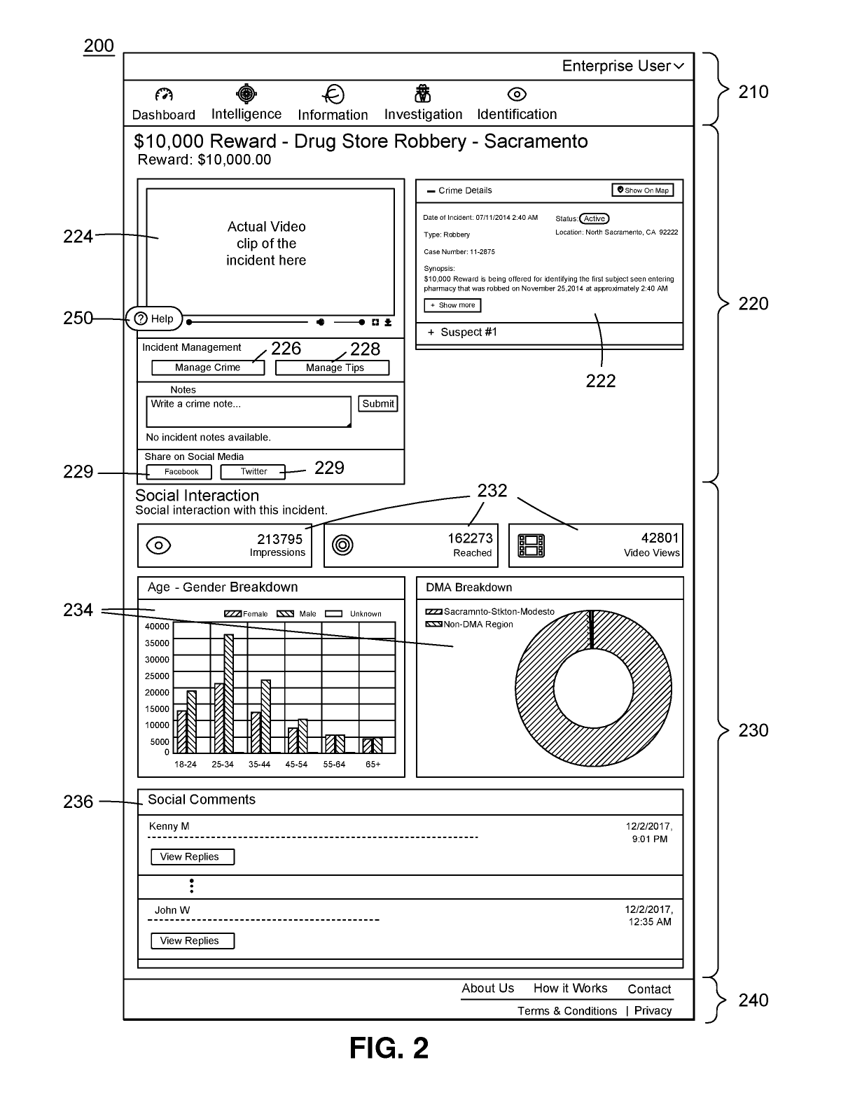

FIG. 1 shows an overview of a system for supporting a criminal investigation according to an embodiment of the present disclosure. A criminal investigation apparatus 100, e.g. a server, receives information about a recent, unsolved crime from a business entity 10. For example, the business entity 10 may have suffered a burglary, and the break-in may have been captured on video by a surveillance camera 12 of the business entity 10. The business entity 10 may provide such surveillance video footage and other information about the crime (e.g. witness reports, known suspect information, location, etc.) to the criminal investigation apparatus 100 using a crime poster user interface (UI) 200 (see FIGS. 2-4) accessible via a web browser or mobile application. With the information provided by the business entity 10, the criminal investigation apparatus 100 then updates a tipster UI 300 to display a new crime posting including the known information about the crime. Public users 20 may find and view the new crime posting while browsing or searching crime postings using the tipster UI 300, e.g. via a web browser or mobile application. If the crime posting is of interest, a public user 20 may share the crime posting on social media (e.g. Facebook®, Twitter®, etc.), causing the information of the crime to propagate to more and more public users 20. In the example of FIG. 1, public user 20-1 shares the new crime posting with several public users 20 including public user 20-2, who then shares the new crime posting with several more public users 20 including public user 20-3. Public user 20-3 recognizes the perpetrator and submits an anonymous tip using the tipster UI 300, which is then received by the criminal investigation apparatus 100 and forwarded to law enforcement 30. Thanks to the anonymous tip provided by public user 20-3, the perpetrator may be found and the crime solved. The user 20-3 may view the status of his/her already submitted tip (e.g. whether it led to an arrest) using the tipster UI 300. In this way, the user 20-3 may find out whether he/she may claim a reward associated with solving the crime.

By its very nature, social media directs information toward relevant audiences. As an idea propagates through social media, individual users actively (e.g. by choosing a recipient or group of recipients) or passively (e.g. by virtue of belonging to a group or other sub-portion of a social network) target other users having some connection to the information. In some cases, the targeting may be even more pronounced as social media algorithms work behind the scenes to prioritize relevant information depending on a user's profile, viewing history, etc. (e.g. more relevant information showing up in a person's social media feed). In the example of FIG. 1, public user 20-1 may, for example, recognize the town where the crime occurred and choose to share the crime posting with some friends of his who attend a high school in that town. Then, public user 20-2 may, for example, broadly share the same crime posting with a social network (e.g. a Facebook® “group”) whose members are all students and alumni of the high school. Public user 20-3, who recognizes the perpetrator and submits the anonymous tip, may not even know public user 20-1 or 20-2, but may know the perpetrator from having attended the same high school several years prior. In this way, the disclosed systems and methods may leverage social media to efficiently propagate a surveillance video or other crime posting information to communities of individuals who are most likely to be able to provide helpful tips. Thus, the limited resources of law enforcement 30 can be put to better use than in the case of relying on conventional methods including crime reporting hotlines and websites.

FIG. 2 shows an example crime details page of the crime poster UI 200, where a business entity user or other crime poster may view and manage an individual uploaded crime posting, as well as view social media interaction information about the crime posting. The crime poster UI 200 may include, on the crime details page, a navigation bar 210, a crime details portion 220, a social media interaction information portion 230, an information bar 240, and a help button 250.

In the example of FIG. 2, a registered user is logged in, as reflected by the user's name “Enterprise User” in the top-right corner of the navigation bar 210. As represented by the downward facing caret, interacting with “Enterprise User” (e.g. by click, touch, mouseover, etc.) may reveal a drop-down menu allowing access to user-related functions such as editing a user profile and logging out. As shown, the navigation bar 210 may also include various navigation buttons, such as “Dashboard,” “Intelligence,” “Information,” “Investigation,” and “Identification,” any or all of which may reveal drop-down menus. These navigation buttons and/or the drop-down menu entries thereof may serve as links to other pages of the crime poster UI 200 as described throughout this disclosure.

The crime details portion 220 may prominently include a crime posting title (e.g. “$10,000 Reward—Drug Store Robbery—Sacramento”) and any reward information (e.g. “Reward: $10,000.00”) and may include a media player for viewing a crime video 224 (e.g. surveillance video, video taken with mobile phone, audio-only media, etc.) associated with the crime posting. The crime details portion 220 may also display various information about the crime posting in text form in a crime details panel 222, which may be sub-divided into expandable and collapsible segments such as a segment showing general information (e.g. “—Crime Details”) and segments for each suspect (e.g. “+Suspect #1”) as shown in FIG. 2. General information about the crime posting may include, for example, “Date of Incident,” “Status” (active, solved, etc.), “Type” of crime posting (e.g. robbery), “Location,” “Case Number” (which may be a record-keeping number and may be automatically assigned by the criminal investigation apparatus 100), and “Synopsis” describing the events of the crime and any reward information. Suspect information may include, for example, gender, height, weight, hair color, eye color, etc. if known, as well as a still capture of the suspect taken from the crime video 224. The crime details panel 222 may also include a “Show On Map” button for displaying the crime posting as a location pointer on an interactive map view.

In addition to such information about the crime posting, the crime details portion 220 may also include functionality to allow a user (in this case the registered user who is logged in) to manage aspects of the crime posting. For example, as shown in FIG. 2, an “Incident Management” panel of the crime details portion 220 may include a “Manage Crime” button 226 for supplementing or modifying the crime posting and a “Manage Tips” button 228 for viewing and responding to anonymous tips. A “Notes” panel may also be provided to allow the user to jot down any notes regarding the crime posting (e.g. potential leads) for later reference. The crime details portion 220 may also include one or more “Share on Social Media” button(s) 229 for sharing the crime posting on Facebook®, Twitter®, or other social media.

The social media interaction information portion 230 may include counts or other indicators of the numbers of various tracked social media interactions 232. For example, tracked social media interactions 232 may include a number of impressions (e.g. the number of times the crime posting has appeared in social media feeds), a number of people reached (e.g. the number of people whose social media feed received the crime posting), and a number of video views. The social media interaction information portion 230 may further include analysis 234 related to the tracked social media interactions 232. Analysis 234 may include, for example, a graph showing demographic breakdown (e.g. age, gender, etc.) of the people reached, a chart showing designated market area (DMA) breakdown of the people reached (e.g. number of people reached inside and outside the geographic area of the crime), etc. The social media interaction information portion 230 may further include social comments 236 compiled from one or more social networks in relation to the crime posting. The social media interaction information displayed in the social media interaction information portion 230, including the tracked social media interactions 232, analysis 234, and social comments 236 may be generated, for example, using an application programming interface (API) of the social media provider or a third-party analytics provider. By providing such social media interaction information, the crime poster UI 200 may allow the crime poster to evaluate the effectiveness of the criminal investigation apparatus 100 in solving the crime. The crime poster may, for example, tailor the uploaded crime posting information while observing the social media interaction information in an effort to reach more people or more relevant people and generate helpful anonymous tips.

The information bar 240 may provide links to service provider information of the provider of the criminal investigation apparatus 100 and/or crime poster UI 200, including entity information, service information, contact information, and/or legal, regulatory, and contractual information. Troubleshooting and other help requests (e.g. by email contact) may be made using a floating help button 250, which may scroll along as the user scrolls a screen of a web browser or mobile application while using the crime poster UI 200.

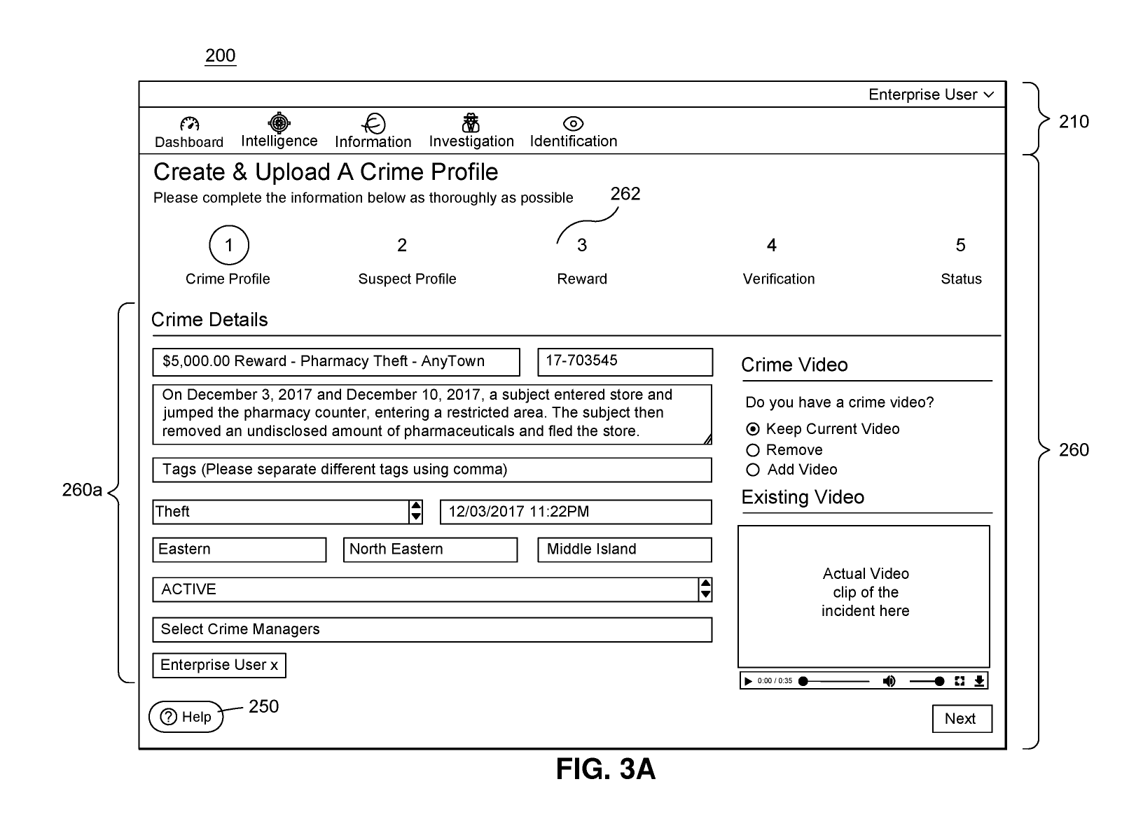

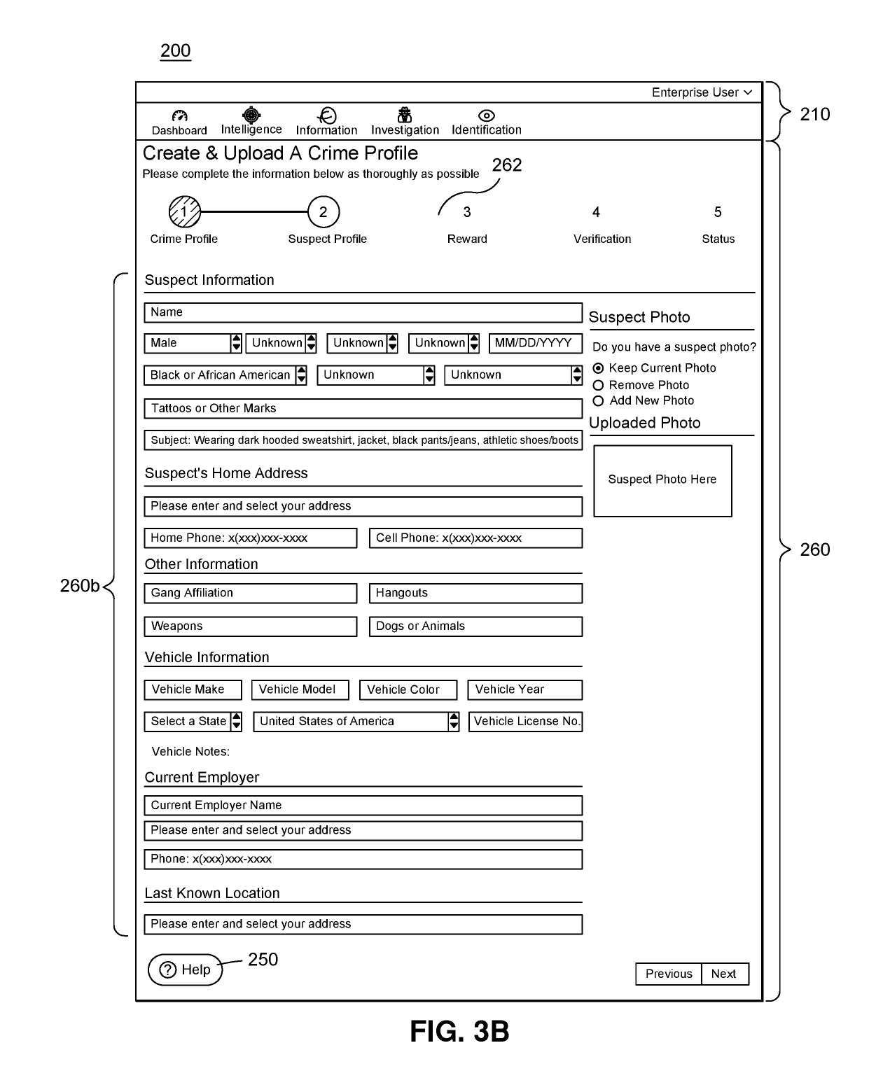

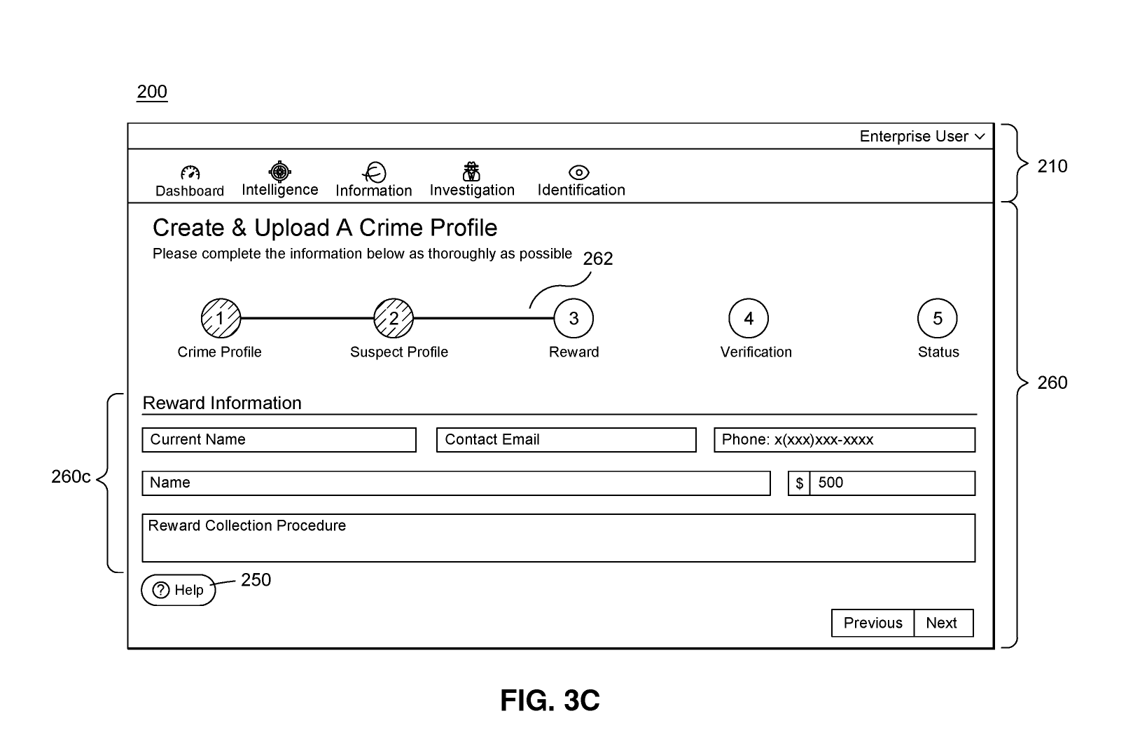

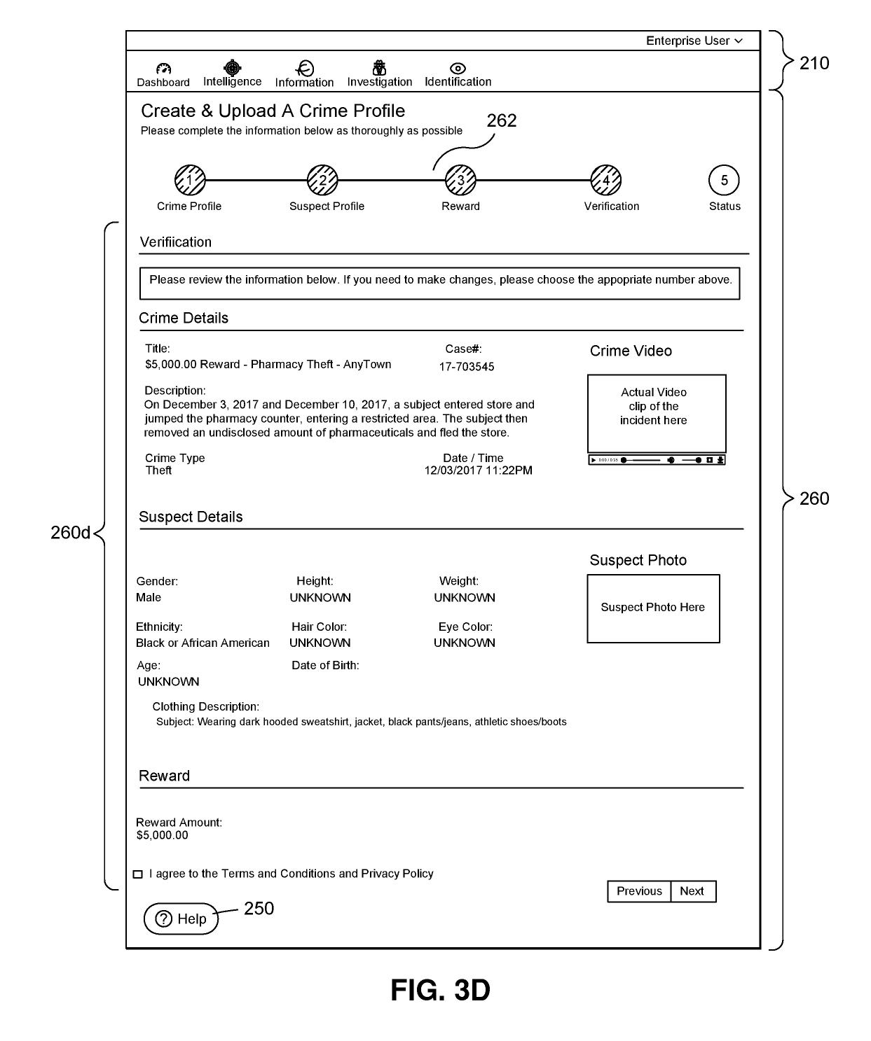

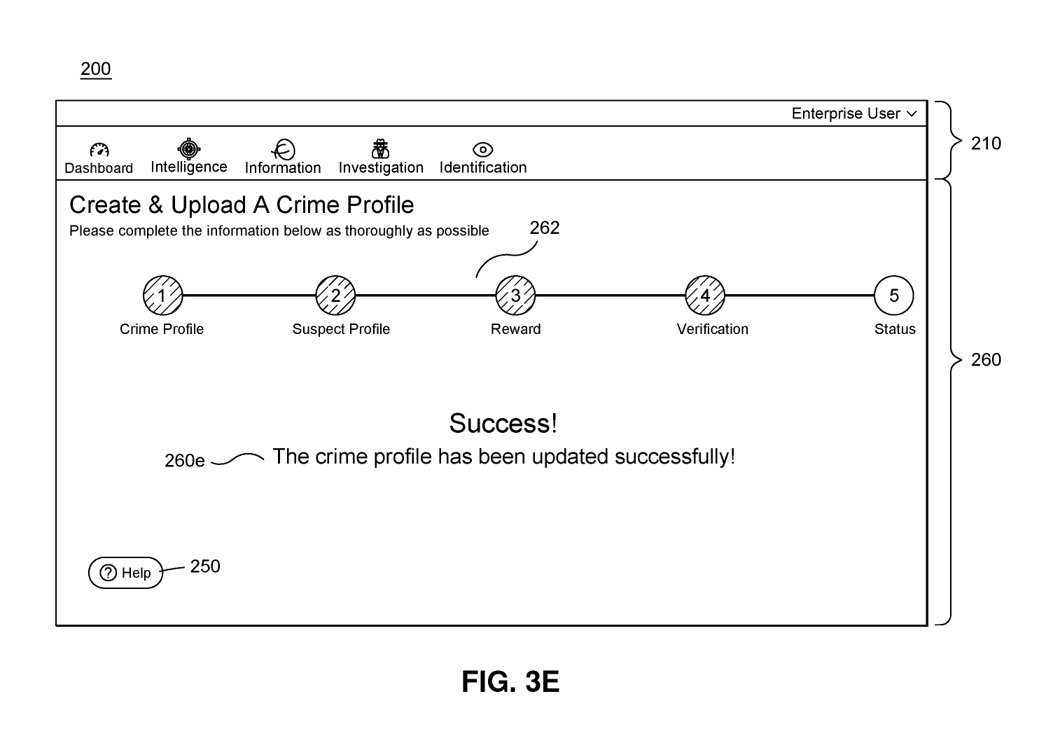

FIGS. 3A-3E show an example series of crime upload pages of the crime poster UI 200, where a business entity user or other crime poster may supplement or modify an existing crime posting or create a new crime posting. Access to the crime upload pages of FIGS. 3A-3E may be via a “Submit New Incident” link in a drop-down menu of the “Investigation” button of the navigation bar 210 of FIG. 2. When the crime poster wants to supplement or modify an existing crime posting, access to the same crime upload pages may be via the “Manage Crime” button 226 in the crime details portion 220 of FIG. 2, in which case the data entry fields etc. shown in FIGS. 3A-3E may be pre-populated with the current crime posting information. Spread across one or more crime upload pages, the crime poster UI 200 may include a crime upload portion 260 in addition to the navigation bar 210, information bar 240, and/or help button 250.

The crime upload portion 260 may include a series of data entry fields, radio buttons, upload tools, etc. for inputting crime posting information and creating/modifying the crime posting, which may be separated into multiple data entry sections such as a crime details data entry section 260a, a suspect information data entry section 260b, and a reward information data entry section 260c, along with a verification page 260d and a status notification page 260e. The crime upload portion 260 may further include a crime upload progress indicator 262 to illustrate the user's progress toward completion of the crime upload process.

As shown in FIG. 3A, the crime details data entry section 260a may include data entry fields for creating or modifying various information about the crime posting such as the crime posting title and the information described in relation to the crime details panel 222 shown in FIG. 2 (e.g. “Date of Incident,” “Status,” “Type,” “Location,” “Case Number,” and “Synopsis”), as well as a crime video upload tool (e.g. a media player for viewing the existing crime video 224 and radio buttons allowing the crime poster to “Keep Current Video,” “Remove,” or “Add Video”). The crime details data entry section 260a may further allow the crime poster to input tags by which the crime posting may be indexed. Tags may describe any aspect of the crime, such as a weapon used (e.g. “knife”), an item stolen (e.g. “prescription medicine”), etc. and may be useful, for example, if a user wishes to search for crime postings having a particular tag. The crime details data entry section 260a may further allow the crime poster to designate one or more tip investigators to be associated with the crime posting, the designated tip investigator being the party responsible for following up on anonymous tips. In the example of FIG. 3A, the designation of the tip investigator may be done by inputting a user name in the “Select Crime Managers” field, and in this example the tip investigator is the crime poster itself (“Enterprise User”). As another example, the crime poster may designate a detective in a local police force or other law enforcement officer or entity as the tip investigator. It is also envisioned that such designation may further entail other responsibilities and allow access to other functionality besides tip investigation, such as supplementing or modifying the crime posting as new information becomes available. When the crime details data entry section 260a is displayed, the crime upload progress indicator 262 may indicate, for example, a first step (e.g. “Crime Profile”) of a multi-step process of creating/modifying the crime posting. A “Next” button may allow the crime poster to navigate to the next step of the process, which may be on a separate page.

As shown in FIG. 3B, the suspect information data entry section 260b may include data entry fields for creating or modifying various information about any known suspects, such as the suspect information described in relation to the crime details panel 222 shown in FIG. 2. Suspect information may include, for example, gender, height, weight, hair color, eye color, date of birth, ethnicity, nationality, language, tattoos or other marks, clothing, home address, phone number, gang affiliation, hangouts, weapons, dogs or other animals, vehicle information (e.g. make, model, color, year, state of registration, license number, or other distinguishing characteristics), employer information, last known location, and any other identifying characteristics of the suspect. The suspect information data entry section 260b may further include a suspect photo upload tool (e.g. a display of the existing photo and radio buttons allowing the crime poster to “Keep Current Photo,” “Remove Photo,” or “Add New Photo”). In some embodiments, the suspect photo upload tool may include a media player for viewing any uploaded crime video 224 and capturing a still of the video containing the suspect. When the suspect information data entry section 260b is displayed, the crime upload progress indicator 262 may indicate, for example, a second step (e.g. “Suspect Profile”) of a multi-step process of creating/modifying the crime posting. A “Next” button may allow the crime poster to navigate to the next step of the process, which may be on a separate page, and a “Previous” button may allow the crime poster to navigate to the previous step (e.g. “Crime Profile”).

As shown in FIG. 3C, the reward information data entry section 260c may include data entry fields for creating or modifying various information about any rewards associated with solving or providing helpful tips toward solving the crime, such as the reward information described in relation to the crime details portion 220 shown in FIG. 2. Reward information may include, for example, reward contact name, email, phone, etc., reward amount (e.g. “$5000”), and information about the reward collection procedure. The information about the reward collection procedure may define, for example, what constitutes a reward-earning tip (e.g. a tip containing the full name of the suspect, a tip containing the whereabouts of the suspect, etc.), when it is established that the tipster has earned a reward (e.g. when the suspect is arrested, when the suspect is convicted, etc.), when the reward is paid, how the reward is paid, etc. When the reward information data entry section 260c is displayed, the crime upload progress indicator 262 may indicate, for example, a third step (e.g. “Reward”) of a multi-step process of creating/modifying the crime posting. A “Next” button may allow the crime poster to navigate to the next step of the process, which may be on a separate page, and a “Previous” button may allow the crime poster to navigate to the previous step (e.g. “Suspect Profile”).

As shown in FIG. 3D, the verification page 260d may include all of the information entered by the crime poster in the “Crime Profile,” “Suspect Profile,” and “Reward” pages, including any uploaded crime videos 224 and suspect photos. The verification page 260d may display an instruction to review the data: e.g. “Please review the information below. If you need to make changes, please choose the appropriate number above.” The verification page 260d may further include a checkbox or other field for indicating agreement with legal, regulatory, and/or contractual requirements (e.g. “I agree to the Terms and Conditions and Privacy Policy”). When the verification page 260d is displayed, the crime upload progress indicator 262 may indicate, for example, a fourth step (e.g. “Verification”) of a multi-step process of creating/modifying the crime posting. A “Submit” button may allow the crime poster to confirm verification and submit the crime posting, and a “Previous” button may allow the crime poster to navigate to the previous step (e.g. “Reward”). The crime poster may also be able to freely navigate to a particular step of the process by interaction with the crime upload progress indicator 262.

Upon interaction with the “Submit” button of the verification page 260d, the crime poster UI 200 may navigate to the status notification page 260e as shown in FIG. 3E, where a success message or failure message may be displayed indicating whether the upload of the crime posting was successful. In the example of FIG. 3E, the uploading of the crime posting data was successful, so the status notification page 260e indicates, “Success! The crime profile has been updated successfully!” If the uploading is not successful, the status notification page 260e may indicate, for example, “Error,” followed by instructions to correct the error. For example, required information may have been omitted and the status notification page 260e may direct the crime poster to enter the required information on one of the previous pages of the crime upload portion 260. As another example, if an Internet connection is lost, the status notification page 260e may indicate that the connection is lost and provide suggestions for fixing the problem. When the status notification page 260e is displayed, the crime upload progress indicator 262 may indicate, for example, a fifth step (e.g. “Status”) of a multi-step process of creating/modifying the crime posting.

In the example of FIGS. 3A-3E, the crime poster has successful updated an existing crime posting. Upon completion of this updating process, a corresponding crime details page of the crime poster UI 200 (e.g. FIG. 2) will be updated to reflect the changes that were made. If, on the other hand, the crime poster had successfully created a new crime posting, a new crime posting will be created having a corresponding crime details page, including a “Manage Crime” button 226 for later supplementing or modifying the new crime posting.

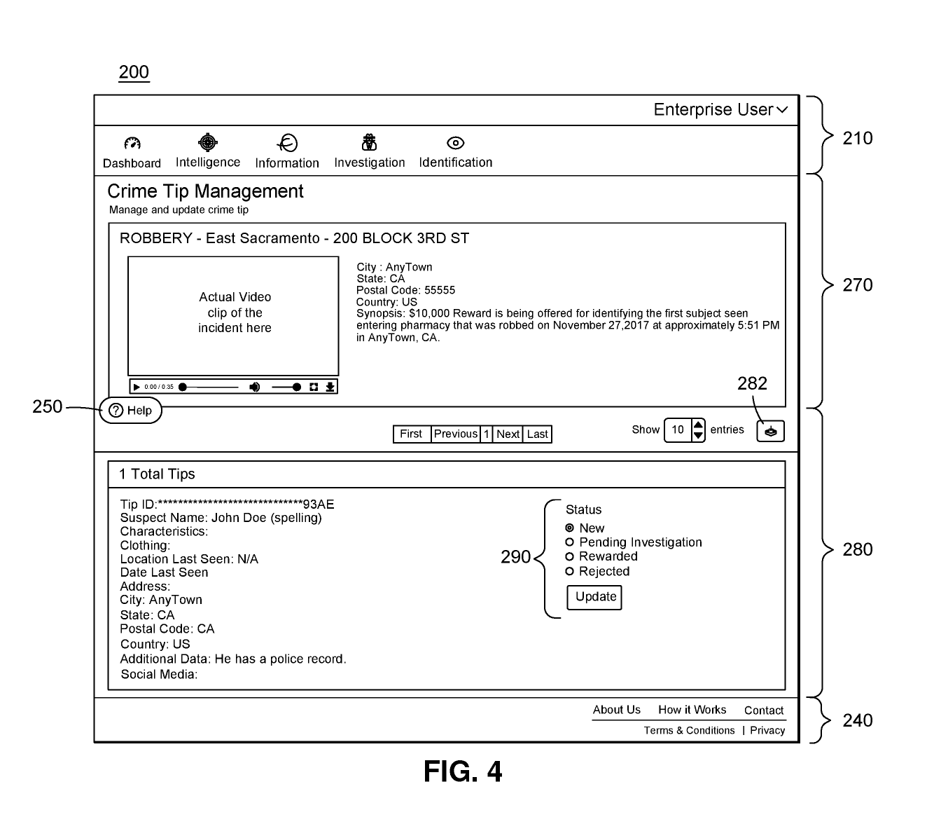

FIG. 4 shows an example tip management page of the crime poster UI 200, where a designated tip investigator may review any anonymous tips that have been submitted with respect to an existing crime posting and update the status of such tips. If the crime poster itself has been designated as the tip investigator, as in the example of FIG. 3A (e.g. “Select Crime Managers—Enterprise User”), access to the tip management page of FIG. 4 may be via the “Manage Tips” button 228 in the crime details portion 220 of FIG. 2. On the tip management page, the crime poster UI 200 may include a crime details portion 270 and a tip details portion 280 in addition to the navigation bar 210, information bar 240, and/or help button 250.

If, on the other hand, another party such as law enforcement 30 (e.g. a detective in a local police force) has been designated as the tip investigator, a tip management page similar to the one shown in FIG. 4 may be accessed via a tip investigator UI 400 (not separately pictured) instead of the crime poster UI 200. For example, the tip investigator UI 400 may include a tip management page that is the same as the tip management page shown in FIG. 4 except that the top-right corner of the navigation bar 210 reflects a different registered user as being logged in, namely the tip investigator. As may be appreciated, the tip investigator may be associated with crime postings of more than one crime poster. For example, in a case where law enforcement 30 has been designated as the tip investigator, there may be many local business entities 10 who have designated the same law enforcement 30 as the tip investigator in relation to their respective crime postings. Thus, the tip investigator UI 400 may include a list of crime postings associated with the tip investigator, and the tip investigator may access the tip management page for a given crime posting from such list. In some cases, the tip investigator UI 400 may further include, for each such crime posting, a crime details page that is the same as the crime details page shown in FIG. 2 except that the top-right corner of the navigation bar 210 reflects a different registered user as being logged in, namely the tip investigator. The crime details page of the tip investigator UI 400 may further differ from the crime details page shown in FIG. 2 in the omission of other functionality that may be geared more toward the crime poster (e.g. the social media interaction information portion 230, the “Share on Social Media” button(s) 229, the “Manage Crime” button 226). In a case where the tip investigator UI 400 includes such a crime details page, a “Manage Tips” button 228 of the tip investigator UI 400 may be used to access the tip management page.

As shown in FIG. 4, the crime details portion 270 of the tip management page (of the crime poster UI 200 or tip investigator UI 400) may include a crime posting title (e.g. “Robbery—East Sacramento—200 BLOCK 3RD ST”) and may include a media player for viewing the crime video 224 associated with the crime posting. The crime details portion 270 may also include information about the crime, such as the information displayed in the crime details panel 222 of the crime details page of FIG. 2 or a summary thereof.

The tip details portion 280 of the tip management page (of the crime poster UI 200 or tip investigator UI 400) may include the content of each anonymous tip that has been submitted with respect to the crime posting and may further include, for each tip, a tip status updater tool 290 that allows the tip investigator to update the status of each tip. The tip details portion 280 may further include navigation tools for navigating through multiple pages of tips for a case where many tips have been submitted. As shown, the navigation tools may include an indication of the current page of tips (e.g. “1”) surrounded by buttons to navigate to the “Previous” and “Next” pages and the “First” and “Last” pages, as well as a selector for how many tips (e.g. “10”) should be shown on each page of tips. A “download” button 282 may also be provided for downloading all tips in the form of a list, table, or spreadsheet in a single document.

The content of each tip may include various fields such as suspect name, characteristics, clothing, location last seen, date last seen, address, city, state, postal code, country, additional data, and social media information such as social media handles. Any or all of the fields may contain information provided by the tipster who submitted the tip. For example, as shown in FIG. 4, the tipster may have only submitted the name of the suspect (“John Doe (spelling)”), the city of residence of the suspect (“AnyTown, Calif.”), and the additional information that “He has a police record.” As another example, a tipster may indicate, for example, some distinguishing characteristic of the suspect, such as that the suspect has a tattoo, or that the suspect was last seen at a particular location. As shown in FIG. 4, the tip details portion 280 may also include a partially hidden indication of a tip identifier (tip ID) associated with the tip (“* * * 93AE”). As described in more detail below, the tip ID may be an alphanumeric code that is generated by the criminal investigation apparatus 100 and only known to the tipster who submitted the tip.

The tip status updater tool 290 may include, for example, radio buttons to set the status of the tip as, e.g., “New,” “Pending Investigation,” “Rewarded,” or “Rejected,” and an “Update” button to confirm the new setting. As new tips are submitted by tipsters with respect to the crime posting, they may appear in the tip details portion 280 with the default status “New.” As the tip investigator browses through the tips, he/she may find that some, but not all, are worthy of investigation. When the tip investigator begins investigating a tip, he/she may set the tip status to “Pending Investigation.” If the tip is eventually discarded as unhelpful, or if the tip was never worthy of investigation to begin with, the tip investigator may set the tip status to “Rejected.” If the tip results in an arrest, conviction, etc. (e.g. depending on the reward collection procedure for the particular crime posting), or in some cases after the reward is paid, the tip investigator may set the tip status to “Rewarded.” The tip status updater tool 290 may serve both as an internal record for the tip investigator and as a way of communicating the status of a pending anonymous tip to the tipster as described in more detail below.

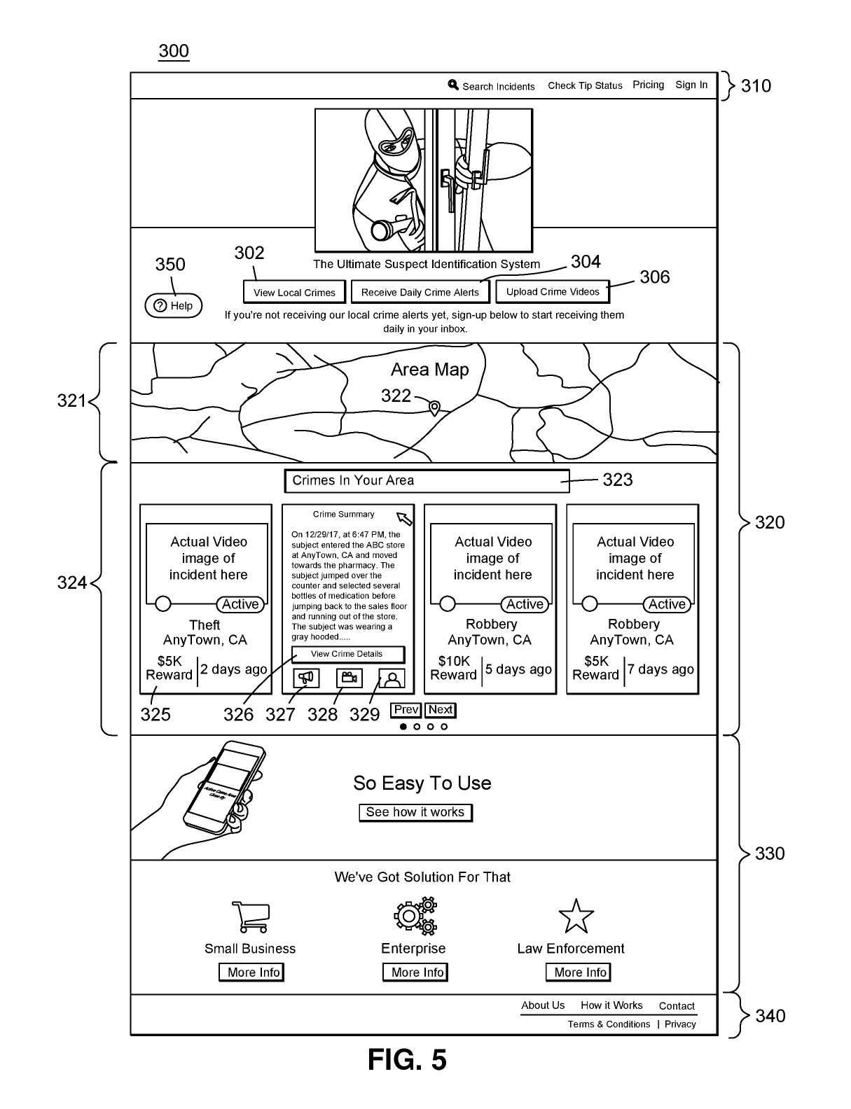

FIG. 5 shows an example homepage of the tipster UI 300, where a public user 20 may browse or search crime postings, submit anonymous tips, check tip status, sign up for crime alerts, and find out more information about the services offered by the provider of the criminal investigation apparatus 100 and/or tipster UI 300. The homepage may also include access by secure login to the crime poster UI 200 and/or tip investigator UI 400. In this regard, the homepage of the tipster UI 300 may serve as a universal homepage for two or more of the tipster UI 300, the crime poster UI 200, and the tip investigator UI 400. In some cases, the tipster UI 300 may correspond to the logged-out state of either or both of the crime poster UI 200 and the tip investigator UI 400. The tipster UI 300 may include, on the homepage, a navigation bar 310, a crime browsing portion 320, a service information portion 330, an information bar 340, and a help button 350. The information bar 340 and help button 350 may be the same as the information bar 240 and help button 250 described in relation to FIG. 2.

In the example of FIG. 3, there is no registered user logged in, as reflected by the “Sign In” button in the top-right corner of the navigation bar 310. The “Sign In” button may allow a crime poster or tip investigator to log in using, for example, an account name, password, and/or multi factor authentication, after which the user may be redirected from the tipster UI 300 to an appropriate dashboard or other homepage associated with the crime poster UI 200 or tip investigator 400. Along the same lines, when a registered crime poster or tip investigator logs out of the crime poster UI 200 or tip investigator 400, he/she may be redirected to the homepage of the tipster UI 300. As shown, the navigation bar 310 may also include various navigation buttons, such as “Search Incidents,” “Check Tip Status,” and “Pricing.” These navigation buttons may serve as links to other pages of the tipster UI 300 as described throughout this disclosure.

The crime browsing portion 320 may include an interactive map 321 and a crime browser 324. The interactive map 321 may be a map view of an area (e.g. a city or subdivision thereof) with location pointers 322 showing the incident locations of crime postings. Each location pointer 322 may include a picture, color, or other symbol representing the type of crime, how recent the crime was, or any other information about the crime posting. Interaction with the location pointer (e.g. by click, touch, mouseover, etc.) may further reveal additional information about the crime posting in summary form and/or a link to a crime details page of the tipster UI 300 for that crime posting. The interactive map 321 may provide functionality to shift the map view (e.g. move the map view northeast by clicking and dragging the map view down and to the left) and/or zoom the map view in or out (e.g. using plus and minus buttons, a scroll wheel on a mouse, a touchscreen “pinch” gesture, etc.). If the web browser or mobile device with which the user accesses the tipster UI 300 is set to allow use of the user's geographic location (e.g. GPS data), then the map view may default to the user's geographic location. After the user has moved the map view, the “View Local Crimes” button 302 may reset the map view to the user's geographic location and/or default zoom setting. By using the interactive map 321, public users 20 may easily learn of recent crimes in the area, which may be the crimes that are of the greatest interest.

The crime details page of the tipster UI 300 for a given crime posting (e.g. reachable via the interactive map 321) may be the same as the crime details page of the crime poster UI 200 shown in FIG. 2 except that the navigation bar 210 may be replaced with the navigation bar 310 to reflect that the user is a public user 20 and not a registered crime poster who has logged in. The crime details page of the tipster UI 300 may further differ from the crime details page shown in FIG. 2 in the omission of other functionality that may not be for public use (e.g. the social interaction portion 230, the “Manage Crime” button 226, the “Manage Tips” button 228, and the “Notes” panel). The crime details page of the tip investigator UI 300 may further differ from the crime details page shown in FIG. 2 in the addition of functionality to submit an anonymous tip (e.g. a copy of the “Submit a Tip” button 327 shown in FIG. 5 and discussed below).

While the interactive map 321 may provide a visual tool for the user to browse crimes by location, the crime browser 324 may provide alternative crime browsing functionality for a user who prefers to scroll through crime postings. To this end, the crime browser 324 may display a scrollable list of crime posting previews 325, each crime posting preview 325 including a thumbnail image of a crime video 224 associated with the crime posting along with some limited information about the crime posting, such as crime type (e.g. “Theft,”), location (“AnyTown, Calif.”), reward information (“$5K Reward”), age of crime posting (e.g. “2 days ago”), crime posting status (e.g. “Active,” “Solved,” etc.), and/or a picture, color, or other symbol representing the type of crime. The crime browser 324 may further include “Previous” and “Next” buttons to allow the user to scroll through additional crime posting previews 325, for example, to cause the displayed set of crime posting previews 325 to move to the left or right, revealing new crime posting previews 325 and hiding others. The crime browser 324 may also include a browsing position indicator (e.g. small circles under “Previous” and “Next” buttons) for providing some indication to the user of the user's browsing position, such as how many crime posting previews 325 or pages of crime posting previews 325 have been browsed or remain to be browsed.

The crime posting previews 325 included in the crime browser 324 may represent a subset of crime postings that may be determined in part by user interaction with a crime browsing selector 323. In the example of FIG. 5, the crime browsing selector 323 is set to “Crimes In Your Area,” which may cause the crime browser 324 to be populated with crime postings having incident locations within a predetermined radius of the user's geographic location. A user may interact with the crime browsing selector 323 to instead select, for example, “Recently Added,” which may populate the crime browser 324 with crime postings that were recently added (e.g. less than a predetermined number of days, weeks, etc. ago), or “Feature Crimes,” which may populate the crime browser 324 with crime postings that are selected to be featured by the provider of the criminal investigation apparatus 100 for any number of reasons (e.g. crime postings having high numbers of views or other interactions, crime postings posted by crime posters having a “premium” account, etc.).

When a user interacts with a crime posting preview 325 (e.g. by click, tap, mouseover, etc.), the crime posting preview 325 may “flip over” or otherwise change to reveal a more detailed “Crime Summary” and various buttons such as a “View Crime Details” button 326, a “Submit a Tip” button 327, a “View Crime Video” button 328, and “Share on Social Media” button(s) 329. The “View Crime Details” button 326 may function as a link to a crime details page of the tipster UI 300 corresponding to that particular crime posting. As described above, the crime details page of the tipster 300 the may have many of the same functions as the crime details page of the crime poster UI 200 shown in FIG. 2. As such, the crime details page of the tipster UI 300 may include functionality for viewing the crime video 224 and sharing the crime posting on social media (e.g. using the “Share on Social Media” button(s) 229 of FIG. 2). As also noted above, the crime details page of the tipster UI 300 may additionally have functionality to submit an anonymous tip. By interacting with the “Submit a Tip” button 327, the “View Crime Video” button 328, and the “Share on Social media” button(s) 329 of the crime posting preview 325, a user may jump to these functions without needing to first open up the crime details page for that crime posting. In this way, a user may, for example, quickly share several local crimes on social media using the crime browser 324 without having to open up each individual crime details page.

As described above, when a user interacts with a crime posting preview 325 displayed in the crime browser 324, the crime posting preview 325 may “flip over” or otherwise change to reveal additional information and functionality. It is also contemplated that the same or equivalent information and functionality may be revealed as the user interacts with each location pointer 322 on the interactive map 321.

The service information portion 330 may include links to informational pages of the tipster UI 300 that provide additional information and instructions regarding the use of the criminal investigation apparatus 100, crime poster UI 200, tipster UI 300, and/or tip investigator UI 400. Such informational pages may also include contact information for help requests and/or signup forms for registering with the criminal investigation apparatus 100, e.g. to become a registered crime poster, a registered tip investigator, or in some cases a registered tipster. A registered tipster may, for example, receive various benefits beyond those received by public users 20, such as daily crime alert emails based on the user's location and/or preferences. In this regard, the homepage of the tipster UI 300 may further have a “Receive Daily Crime Alerts” button 304, which may function as a link to a signup page to register for daily crime alerts. The homepage of the tipster UI 300 may also have an “Upload Crime Videos” button 306, which may function as a link to pricing information for becoming a registered crime poster. Pricing information may also be accessed by a “Pricing” button of the navigation bar 310. In this way, the service information portion 330 and various other portions of the homepage may serve as a gateway for business entities and other crime posters 10, public users 20, and law enforcement 30 alike.

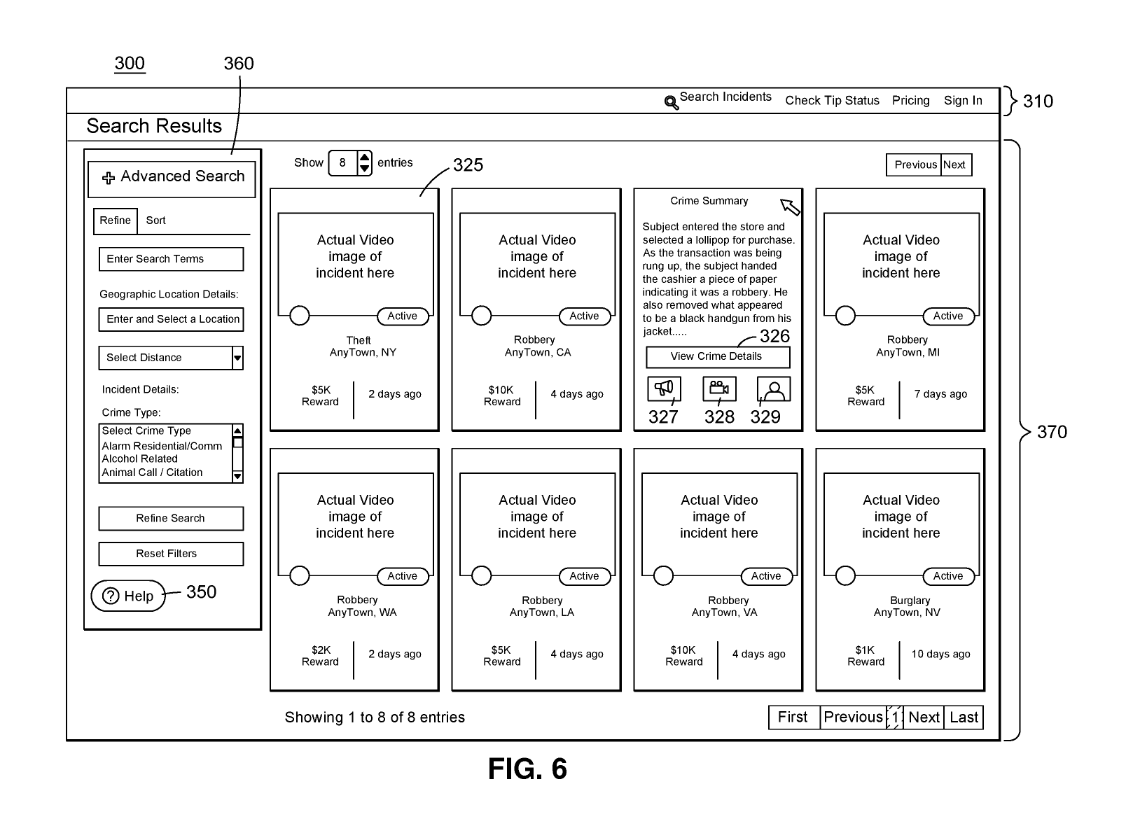

FIG. 6 shows an example search page of the tipster UI 300, where a public user 20 may enter search terms, select filters, etc. to conduct a search of crime postings. In this way, the user may view a subset of crime postings satisfying criteria specified by user interaction with the tipster UI 300. A user may access the search page of FIG. 6 by interacting with the “Search Incidents” button of the navigation bar 310 on the homepage of the tipster UI 300. In addition to the navigation bar 310, information bar 340 and/or help button 350, the search page may include a search query panel 360 that may be expandable and collapsible between an advanced search tool and a simple search tool. In the example of FIG. 6, the advanced search tool is shown, including, in addition to a field to “Enter Search Terms,” various filter selectors organized under a “Refine” tab and various sort selectors (not shown) under a “Sort” tab. Collapsing the search query panel 360 to the simple search tool may, for example, hide everything except the “Enter Search Terms” field. A user wishing to conduct a search may type in one or more search terms in the “Enter Search Terms” (or leave the field blank) and select from among the various filters of the advanced search tool. Filters may include, for example, geographic location details such as a location of interest and a maximum distance from the selected location and incident details such as the type of crime (e.g. “Alarm Residential/Commercial,” “Alcohol Related,” “Animal Call/Citation,” “Robbery,” “Assault,” etc.), which may be selected from a list. The search may be conducted or refined using the “Refine Search” button, and filters may be deselected using the “Reset Filters” button. Under the “Sort” tab, radio buttons or other selectors may allow the user to sort the search results by, for example, newest, oldest, lowest reward, highest reward, distance, incident type, etc.

When the user conducts a search using the search query panel 360, the search results may appear in a search results portion 370 of the search page. The search results may appear in the search results portion 370 as crime posting previews 325 that are the same as those described above with respect to the crime browsing portion 320 of the homepage of the tipster UI 300. In the example search page of FIG. 6, the crime posting previews 325 are organized in pages of 8 entries, which may be adjustable using navigation tools including an indication of the current page of crime posting previews 325 (e.g. “1”) surrounded by buttons to navigate to the “Previous” and “Next” pages and the “First” and “Last” pages, as well as a selector for how many crime posting previews 325 (e.g. “8”) should be shown on each page. The crime posting previews 325 displayed in the search results portion 370 of the search page may be interacted with in the same way as the crime posting previews 325 displayed in the crime browsing portion 320 of the homepage and my link to various other pages and functionality of the tipster UI 300 as described above.

When a user wishes to share a crime posting on social media (e.g. Facebook®, Twitter®, etc.), he/she may click the “Share on Social Media” button 329 of the corresponding crime posting preview 325 displayed in the crime browsing portion 320 or in the search results portion 360 or the “Share on Social Media” button 329 of the corresponding crime details page of the tipster UI 300 (e.g. after having clicked the “View Crime Details” button 326). In the same way, in order to increase exposure of one's own posted crime, a crime poster user might similarly click the “Share on Social Media” button 229 on the crime details page of the crime poster UI 200 shown in FIG. 2. In either case, the “Share on Social Media” button 329, 229 might be one of a plurality of adjacent buttons, each corresponding to different social media (e.g. a Facebook® button and a Twitter® button). When a user interacts with a “Share on Social Media” button 329, 229, the UI 300, 200 may allow the user to share one or more content items of the new crime posting (e.g. a crime video, title, location, and/or synopsis associated with the crime posting, the crime preview 325 corresponding to the crime posting, etc.) on the selected social media, along with a link to the URL of the crime details page for the crime posting. For example, interacting with the “Share on Social Media” button 329, 229 may auto-populate an unpublished social media post and present the unpublished post (e.g. on a separate page or pop-up window) for the user's confirmation and publication and/or to receive the user's social media login credentials. The criminal investigation apparatus 100 may implement such social media sharing functionality using any known methods (e.g. HTML code generators provided by Facebook®, Twitter®, etc.). By allowing crime postings to be easily shared on social media, the criminal investigation apparatus 100 makes it possible for the crime poster to reach a much larger audience of relevant potential tipsters as described above. The results of such sharing and re-sharing can then be tracked by the crime poster using the social media interaction information portion 230 as described above, allowing the crime poster to finetune the crime posting to reach larger and more relevant audiences.

When a user wishes to submit an anonymous tip for a particular crime posting, he/she may click the “Submit a Tip” button 327 of the corresponding crime posting preview 325 displayed in the crime browsing portion 320 or in the search results portion 360 or the “Submit a Tip” button 327 of the corresponding crime details page of the tipster UI 300 (e.g. after having clicked the “View Crime Details” button 326 or a link in a social media post). Upon interacting with the “Submit a Tip” button 327, the user will be provided with a set of information fields (e.g. on a separate page or pop-up window), any or all of which may be filled out by the user with regard to his/her knowledge of the crime incident and/or suspect. As noted above, the content of a tip may include suspect name, characteristics, clothing, location last seen, date last seen, address, city, state, postal code, country, additional data, and social media information such as social media handles. When the user finishes entering such information into the fields, the user may click a “Submit” button to create the anonymous tip (or a “Cancel” button to cancel). The newly created anonymous tip will now appear on the crime poster UI 200 viewable by the corresponding crime poster and/or on the tip investigator UI 400 viewable by the designated tip investigator as described above in relation to FIG. 4.

Upon submission of the new anonymous tip, the tipster UI 300 may display, for the user who submitted the tip, a unique tip ID as described above. The display of the unique tip ID may be a one-time display, for example, next to the “Submit” button or on a separate page or pop-up window, which will not be viewable outside the current browser or mobile application session (e.g. after the user closes the window). It may be the user's own responsibility to write down the tip ID or commit the tip ID to memory for later use. While it is contemplated that a tipster may elect to receive the tip ID in an email or other communication outside the crime poster UI 200, such embodiments may sacrifice some degree of anonymity for the sake of convenience. In any case, the tip ID may be the sole means by which the tipster may later check the status of the tip and/or claim an associated reward.

A tipster may check the status of an already-submitted anonymous tip by interacting with a “Check Tip Status” button of the navigation bar 310. Upon interacting with the “Check Tip Status” button, the user will be prompted (e.g. on a separate page or pop-up window) to provide a tip ID. When the tipster provides a tip ID that is recognized by the criminal investigation apparatus 100, the tipster UI 300 may display the status of the tip for the user who provided the tip ID. The status of the tip may correspond to the status as updated by the tip investigator using the tip status updater tool 290 and may include, for example, “New,” “Pending Investigation,” “Rewarded” (or “Reward-Eligible”), or “Rejected.” If the status indicates that the tipster is eligible for a reward, the tip status may further include details about how and when to claim the reward Like the tip ID, the tip status may be intended for the particular tipster's eyes only. Thus, the display of the tip status may similarly not be viewable outside the current browser or mobile application session (e.g. after the user closes the window), unless the tip status is again checked using the tip ID.

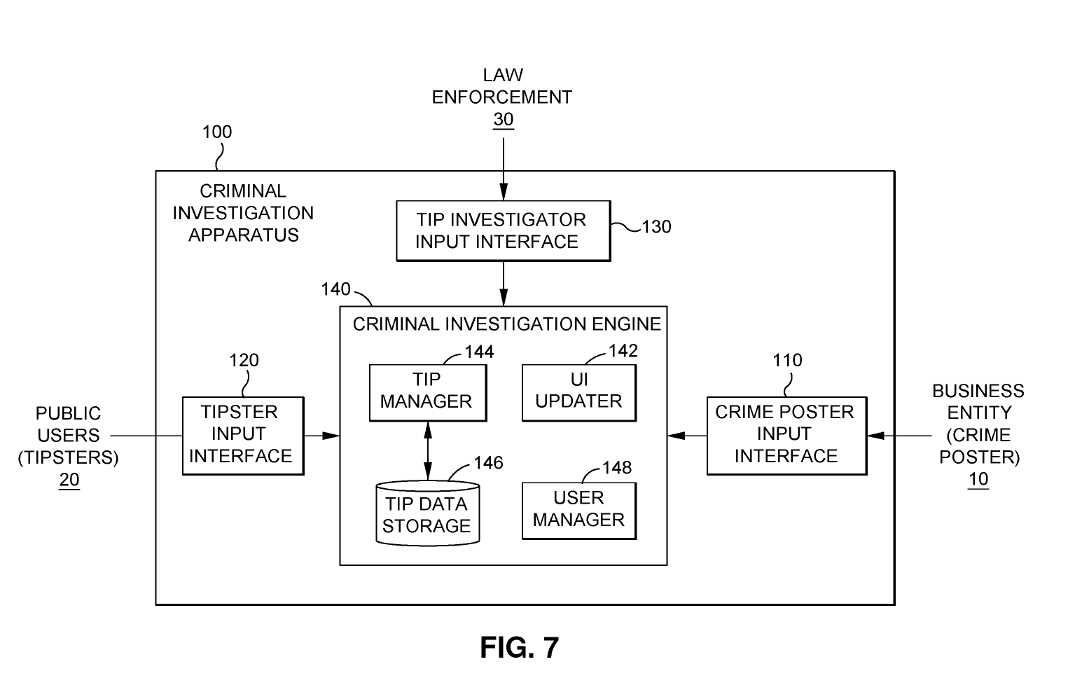

FIG. 7 shows an example criminal investigation apparatus 100 according to an embodiment of the present disclosure. As described above with respect to FIG. 1, the criminal investigation apparatus 100 may act as an intermediary between a business entity or other crime poster 10 who suffers a crime, public users 20 who provide anonymous tips with respect to the crime, and, in some cases, a separate law enforcement entity 30 who follows up on the tips and solves the crime. In particular, as described above with respect to claims 2-6, the criminal investigation apparatus 100 may generate a crime poster UI 200, a tipster UI 300, and a tip investigator UI 400, receive various data generated by user interaction with the crime poster UI 200, tipster UI 300, and tip investigator UI 400, and, on the basis of such received data, update the crime poster UI 200, tipster UI 300, and tip investigator UI 400 to present relevant information to the appropriate parties. The criminal investigation apparatus 100 may include a crime poster input interface 110, a tipster input interface 120, a tip investigator input interface 130, and a crime investigation engine 140.

The crime poster input interface 110 may receive crime posting data generated by user interaction with the crime poster UI 200. As noted above, the crime poster UI 200 may be accessible via a web browser or mobile application. A business entity or other crime poster 10 may, for example, log in (e.g. beginning at the homepage shown in FIG. 5) and navigate to a series of crime upload pages of the crime poster UI 200 as shown in FIGS. 3A-3E. The crime posting data received by the crime poster input interface 110 may be generated by the interaction of the crime poster 10 with the crime upload pages of the crime poster UI 200. Such crime posting data may include, for example, data representative of the entries to the various fields of the crime details data entry section 260a (including location data that may be used to generate a location pointer 322 on an interactive map 321 as shown in FIG. 5), suspect information data entry section 260b, and reward information data entry section 260c, as well as any crime video 224 and/or suspect photo uploaded using the crime video upload tool and/or suspect photo upload tool. The crime poster input interface 110 may further receive a designation command generated by user interaction with the crime poster UI 200, the designation command designating a tip investigator associated with the crime posting data. For example, the designation command may be generated based on the selection of a “Crime Manager” in the crime details data entry section 260a.

The criminal investigation engine 140 (e.g. a UI updater 142 thereof) may update the tipster UI 300 to display a new crime posting based on the crime posting data received by the crime poster input interface 110. As noted above, the tipster UI 300 may be accessible via a web browser or mobile application. The UI updater 142 may, for example, update local files to reflect the new crime posting when serving content to a web browser or mobile application accessing the tipster UI 300. A public user or other tipster 20 may view the new crime posting using the tipster UI 300, for example, by using the interactive map 321 or crime browser 324 of the crime homepage shown in FIG. 5, by using the search page shown in FIG. 6, and/or by viewing a crime details page of the tipster UI 300 corresponding to the new crime posting.

The tipster input interface 120 may receive tip data generated by user interaction with the tipster UI 300. With the tipster UI 300 having been updated to reflect the new crime posting, a public user or other tipster 20 may submit an anonymous tip with respect to the new crime posting as described above, for example, using a “Submit a Tip” button 327 provided on the crime posting preview 325 or on the crime details page corresponding to the new crime posting. The tip data received by the tipster input interface 120 may be generated by the interaction of the tipster 20 with the tip information fields described above in relation to the “Submit a Tip” button 327. Such tip data may include, for example, data representative of the entries to the various fields in which the tipster 20 input information about the crime incident and/or suspect. In order for the criminal investigation apparatus 100 to properly connect the tip data with the new crime posting, the tip data may further include a reference to the new crime posting, e.g., a data field representative of the crime posting whose “Submit a Tip” button 327 was clicked.

The criminal investigation engine 140 (e.g. a tip manager 144 thereof) may generate a unique tip ID and store the tip ID in association with the tip data received by the tipster input interface 120. As noted above, the tip ID may be an alphanumeric code that is only revealed to the tipster 20 who submitted the tip. The tip ID should be unique in the sense that it is satisfactorily unlikely to be the same as any other tip ID or, in some cases, any other tip ID of a currently active tip (e.g., in embodiments where tip IDs may be reused after expiration of the tip). The tip ID should also not be practically guessable. The tip manager 144 may generate the tip ID so as to meet any such conditions by known methods, for example, using appropriately seeded pseudorandom number generators and/or hash functions. The tip ID and associated tip data may be stored in a tip data storage 146 of the criminal investigation engine 140.

The criminal investigation engine 140 (e.g. the UI updater 142) may further update the tip investigator UI 400 to display an anonymous tip based on the tip data received by the tipster input interface 120 and stored in the tip data storage 146. As noted above, the tip investigator UI 400 may be accessible via a web browser or mobile application. The UI updater 142 may, for example, update local files to reflect the new anonymous tip when serving content to a web browser or mobile application accessing the tip investigator UI 400. A law enforcement officer or other tip investigator 30 may view the anonymous tip using the tip investigator UI 400, for example, by using the tip management page described in relation to FIG. 4, and may update the status of the new tip, for example, using the tip status updater tool 290. In this way, the tip investigator input interface 130 may receive tip status data generated by user interaction with the tip investigator UI 400. The tip status data may include, for example, data representative of the updated status, and may further include data representative of instructions or contact information in the case of a reward-eligible tip. The tip status data may further include or be accompanied by a reference to the tip ID of the tip whose status was updated. The criminal investigation engine 140 (e.g. the tip manager 144) may store the tip status data in the tip data storage 146 in association with the tip ID.

As noted above, in a case where the crime poster 10 him/herself is the designated tip investigator, the tip management page described in relation to FIG. 4 may be a tip management page of the crime poster UI 200 rather than a tip management page of the tip investigator UI 400. In such case, the criminal investigation engine 140 (e.g. the UI updater 142) may instead update the crime poster UI 200 to display the anonymous tip, which may then be viewed by the crime poster 10 him/herself, and the crime poster input interface 110 may receive the tip status data.

The tipster input interface 120 may receive a tip status request generated by user interaction with the tipster UI 300. For example, as described above, the tipster 20 may check the status of an already-submitted tip, for example, by using the “Check Tip Status” button of the navigation bar 310 shown in FIG. 5 and inputting the tip ID associated with the tip. Such user interaction with the tipster UI 300 may generate a tip status request including the tip ID. In response to the tip status request, the criminal investigation engine 140 (e.g. the UI updater 142) may update the tipster UI 300 to display a tip status based on the tip status data stored in association with the tip ID included in the tip status request. For example, the tip manager 144 of the criminal investigation engine 140 may search the tip data storage 146 for a data entry associated with the tip ID included in the tip status request. The tip manager 144 may then retrieve the data from the tip data storage 146, including any tip status data stored in association therewith. The UI updater 142 may then update the tipster UI 300 to display the tip status using the tip status data retrieved from the tip data storage 146 by the tip manager 144.

As described above, access to one or more of the crime poster UI 200, the tipster UI 300, and the tip investigator UI 400, or one or more pages thereof, may be limited to certain parties (e.g. registered users, “premium” users, designated tip investigators, etc.). For example, access to the tip investigator UI 400 may be limited by secure login to the tip investigator designated by the designation command received by the crime poster input interface 110. As another example, access to the crime poster UI 200 may similarly be limited to a registered user by secure login. While access to the tipster UI 300 may be open to unregistered users, e.g. in furtherance of anonymity, it is also contemplated that access to the tipster UI 300, or certain “premium” pages and functions thereof, may be limited to registered users by secure login. To these ends, the criminal investigation engine 140 may further include a user manager 148. The user manager 148 may store user account information, e.g. identifying information, payment information, contact information, usernames, passwords, etc. and may, by any known methods, effectuate secure login to the various disclosed user interfaces to enforce such limited access rules.

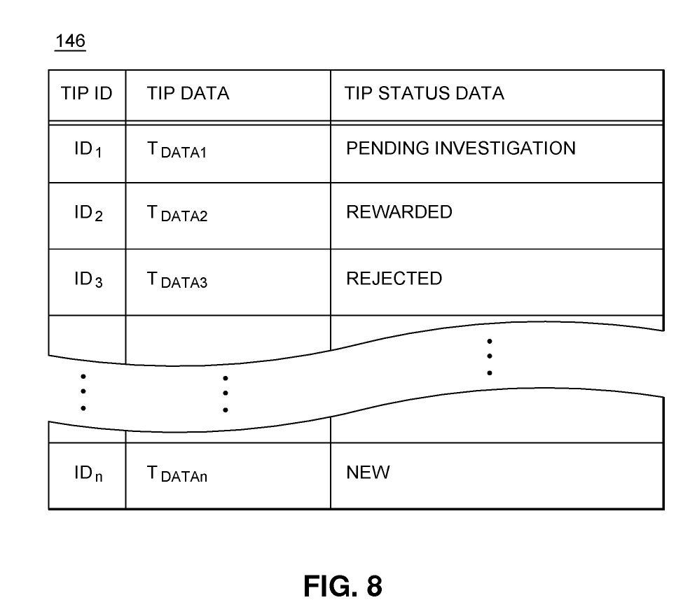

FIG. 8 shows example contents of the tip data storage 146. As illustrated in tabular form by way of example, a plurality of tip IDs (ID₁, ID₂, ID₃, . . . IDₙ) are stored in association with respective tip data (TData₁, TData₂, TData₃, . . . , TDataₙ). As described above, the tip manager 144 of the criminal investigation engine 140 may generate a new tip ID in response to the receipt of new tip data by the tipster input interface 120. The tip manager 144 may then store the new tip data (which may include a reference to a particular crime posting) in association with the newly generated tip ID. Thus, for example, a newly generated tip IDₙ may be stored in association with new tip data TDataₙ representing a newly received anonymous tip regarding a particular crime posting. As shown in FIG. 8, tip status data may also be stored in association with each of the tip IDs. For example, the tip investigator input interface 130 may receive tip status data representing an updated tip status (e.g. “Pending Investigation,” etc.) as updated by a law enforcement officer or other tip investigator 30. In the case of a new tip like the tip associated with IDₙ in FIG. 8, a tip status data field may be initially left blank or may be given a default value such as “New.” Later, when the tip investigator 30 updates the tip status, the tip manager 144 may replace the stored tip status data with tip status data representing the updated tip status. For example, as noted above, a reference to the tip ID may accompany or be included in the tip status data received by the tip investigator input interface 130. The tip manager 144 may locate such tip ID in the tip data storage 146 and overwrite any associated tip status data with the new tip status data. As can be appreciated, when a tipster 20 later wants to check the status of an already-submitted tip, the data structure shown in FIG. 8 allows a tip status request to easily be resolved with only a tip ID inputted by the requesting tipster 20. The tip manager 144 may simply retrieve the tip status data stored in association with the tip ID of the tip status request.

By virtue of its structure and functionality as described above, it is possible for the criminal investigation apparatus 100 to deliver tips from tipsters 20 to law enforcement 30 as well as to provide on-demand tip status updates from law enforcement 30 to tipsters 20, without ever needing to associate any data with identifying information of a person (such as an email address). In this way, the anonymity of the tipsters 20 can be preserved, making it safe for tipsters 20 to submit tips without fear of retaliation by the perpetrators.

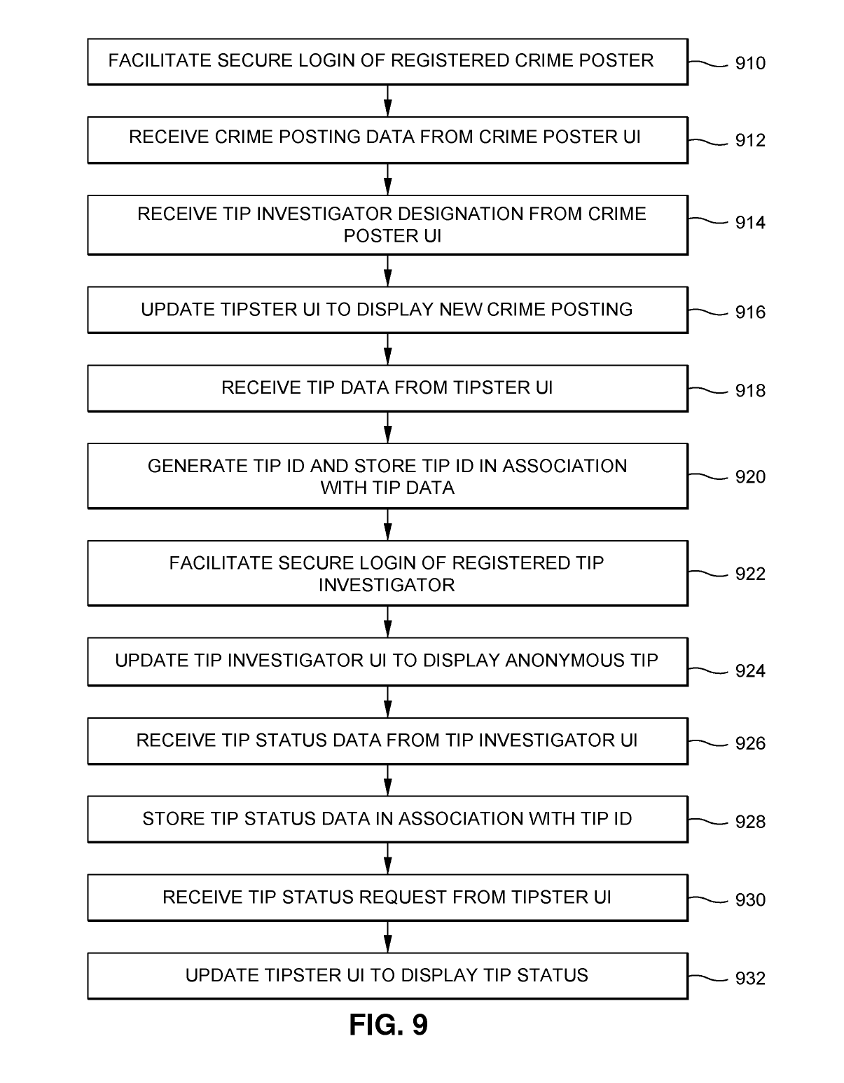

FIG. 9 shows an example operational flow according to an embodiment of the present disclosure. Referring by way of example to the criminal investigation apparatus 100 shown in FIG. 7, the user manager 148 of the criminal investigation engine 140 may facilitate the secure login of a registered crime poster 10 who would like to access the crime poster UI 200 (step 910). Once logged in, the registered crime poster 10 may interact with the crime poster UI 200 to submit a new crime posting. The crime poster input interface 110 may receive crime posting data (step 912) and a tip investigator designation (step 914) accordingly. Based on the received crime posting data, the UI updater 142 of the criminal investigation engine 140 may update the tipster UI 300 to display the new crime posting (step 916). The new crime posting may be shared and re-shared on social media using the tipster UI 300 and/or the crime poster UI 200. When a public user 20 (e.g. public user 20-3 of FIG. 1) submits an anonymous tip in association with the new crime posting, the tipster input interface 120 may receive tip data accordingly. The tip manager 144 may generate a tip ID and store the tip ID in the tip data storage 146 in association with the received tip data (step 920).

The user manager 148 may additionally facilitate the secure login of a law enforcement officer or other registered tip investigator 30 who is responsible for following up on anonymous tips using the tip investigator UI 400 (step 922). The UI updater 142 may update the tip investigator UI 400 to display the anonymous tip based on the received tip data (step 924), after which the tip investigator 30 may view the tip and update the status thereof using the tip investigator UI 400. The tip investigator input interface 130 may thus receive tip status data (step 926), and the tip manager 144 may store the received tip status data in the tip data storage 146 in association with the tip ID (step 928). Later, when the public user 20 wishes to check the status of the anonymous tip, he/she may submit a tip status request, including the tip ID, using the tipster UI 300. The tipster input interface 120 may receive the tip status request (step 930) and the tip manager 144 may locate the tip status data that was stored in the tip data storage 146 in association with the tip ID of the tip status request. The UI updater 142 may then update the tipster UI 300 to display the requested tip status to the public user 20 (step 932).

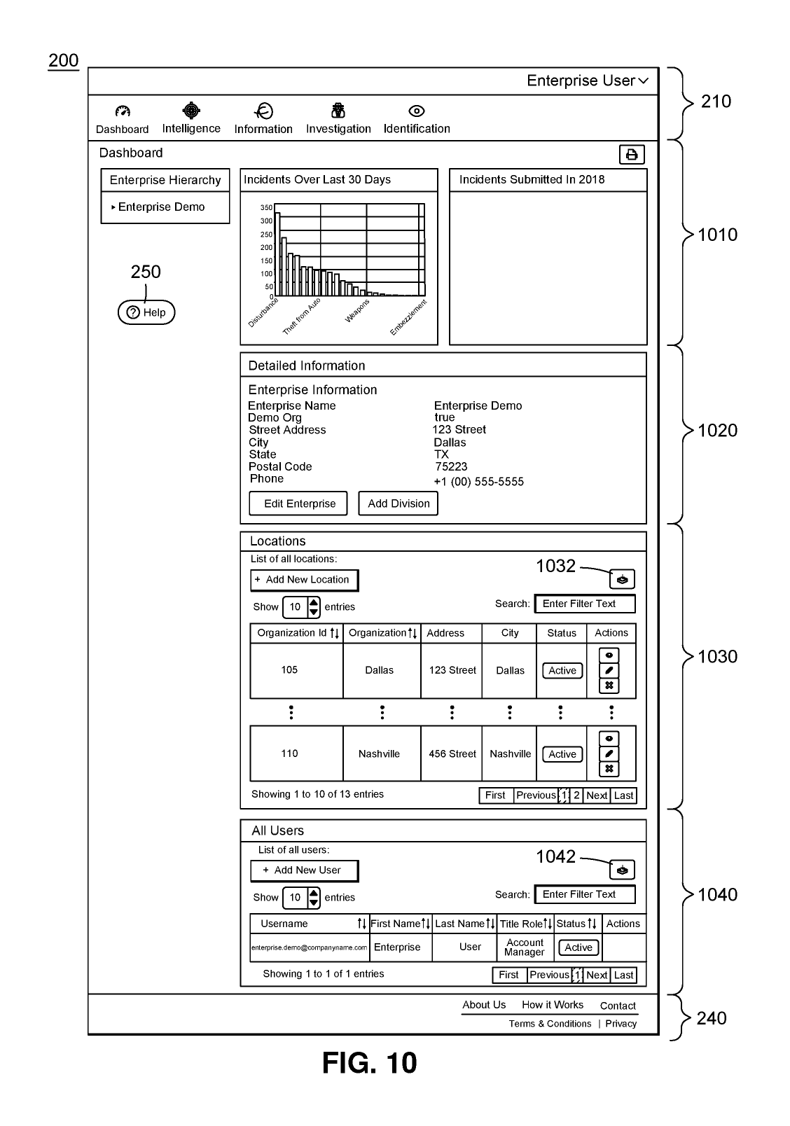

FIG. 10 shows an example enterprise dashboard of the crime poster UI 200, where a registered crime poster (e.g. “Enterprise User”) may view and manage information associated with a business enterprise having multiple geographic locations and/or multiple authorized users of the crime poster UI 200. The enterprise dashboard shown in FIG. 10 may, for example, be the page that a registered crime poster is redirected to upon logging in (e.g. using the “Sign In” link on the homepage shown in FIG. 5). Once logged in, the registered crime poster may return to the enterprise dashboard using the “Dashboard” button of the navigation bar 210. In some cases, the enterprise dashboard may only be available to a subset of registered crime posters (e.g. those who register as a business enterprise with more than one location). On the enterprise dashboard, the crime poster UI 200 may include a recent incidents report 1010, an enterprise information portion 1020, a location list 1030, and a user list 1040 in addition to the navigation bar 210, information bar 240, and/or help button 250.

The recent incidents report 1010 may display information about recent crime postings submitted by the registered crime poster (or another authorized registered crime poster) on behalf of the business enterprise. Such information may include, for example, a graph or chart visually depicting recent incidents organized by incident type (e.g. “Incidents Over Last 30 Days”), a list of recently submitted crime postings (e.g. “Incidents Submitted In 2018”), etc.

The enterprise information portion 1020 may include basic information about the business enterprise as registered with the criminal investigation apparatus 100, for example, enterprise name, address, and contact information. The enterprise information portion 1020 may further include purchase information in relation to services for which the business enterprise has registered. Such purchase information may include, for example, subscription information including subscription type, contract start/end/renewal dates, number of permitted crime postings (e.g. per month, remaining), etc. Functionality of the enterprise information portion 1020 may include, for example, buttons for editing information of the business enterprise, adding a new division of the business enterprise, etc.

The location list 1030 may display a list, such as a table, of locations (e.g. stores, sites, buildings, offices, branches, etc.) of the business enterprise. Each entry in the location list 1030 may include, for example, a location ID (e.g. “Organization ID,” which may be an alphanumeric code assigned by the crime poster or automatically as singed by the criminal investigation apparatus 100), a location name (e.g. “Organization,” an address of the location, a location status (e.g. “Active,” “Defunct,” etc.), and functional links to various actions, such as viewing location details, editing location details, deleting locations, etc. Interacting with one or more of the various links may allow the user to navigate to a page devoted only to the selected location of interest, which may include similar information as the enterprise dashboard but with a focus on the single location (or in some cases on a subset of locations, such as a selected geographic division of the business enterprise). For example, the user may navigate to a “Dallas” page including, for example, “Incidents Over Last 30 Days,” “Incidents Submitted In 2018,” etc. associated with the “Dallas” location. Interacting with a location in the location list 1030 may also allow viewing of a subset of crime postings associated with the location. The location list 1030 may further include navigation tools for navigating through multiple pages of locations. As shown, the navigation tools may include an indication of the current page of locations (e.g. “1”) surrounded by buttons to navigate to the “Previous” and “Next” pages and the “First” and “Last” pages, as well as a selector for how many locations (e.g. “10”) should be shown on each page of locations. A “download” button 1032 may also be provided for downloading all locations in the form of a list, table, or spreadsheet in a single document.

The user list 1040 may display a list, such as a table, of users authorized to access the crime poster UI 200 on behalf of the business enterprise. Each entry in the user list 1040 may include, for example, a username (e.g. “enterprise.demo@companyname.com,” first and last names of the user, information about the user's title/role, user status (e.g. “Active,” “Suspended”), and functional links to various actions, such as viewing user details, editing user details, deleting users, etc. The user list 1040 may further include navigation tools for navigating through multiple pages of users. As shown, the navigation tools may include an indication of the current page of users (e.g. “1”) surrounded by buttons to navigate to the “Previous” and “Next” pages and the “First” and “Last” pages, as well as a selector for how many users (e.g. “10”) should be shown on each page of users. A “download” button 1042 may also be provided for downloading all users in the form of a list, table, or spreadsheet in a single document.

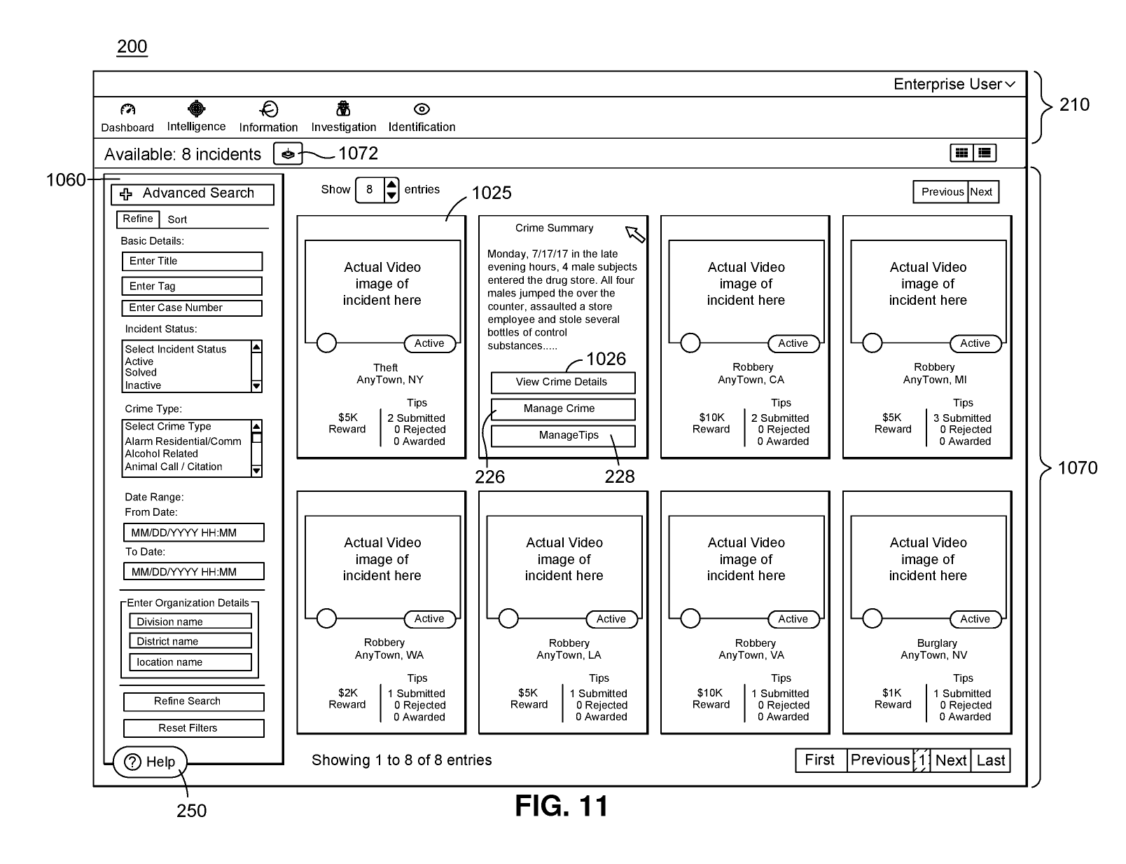

FIG. 11 shows an example enterprise incidents page of the crime poster UI 200, where a registered user may view crime postings associated with locations of the user's business enterprise. A user may access the enterprise incidents page of FIG. 11 by interacting with a “My Incidents” entry in a drop-down menu of the “Investigation” button of the navigation bar 210 (e.g. on the enterprise dashboard of the crime poster UI 200). In addition to the navigation bar 210, information bar 240 and/or help button 250, the enterprise incidents page may include a search query panel 1060 that may be expandable and collapsible between an advanced search tool and a simple search tool. In the example of FIG. 11, the advanced search tool is shown, including various search term entry fields and filter selectors organized under a “Refine” tab and various sort selectors (not shown) under a “Sort” tab.

A user wishing to conduct a search of crime postings associated with the business enterprise may type in one or more search terms in one or more fields for “Title,” “Tags,” “Case Number,” etc. (or leave all fields blank) and select from among the various filters of the advanced search tool. Filters may include, for example, incident status (e.g. “Active,” “Solved,” “Inactive”), crime type, incident date range, and organization detail fields such as “Division Name,” “District Name,” “Location Name,” etc. The search may be conducted or refined using the “Refine Search” button, and filters may be deselected using the “Reset Filters” button. For example, if the user wanted to see all crime postings within the last three months at the Dallas location, the user might simply enter the appropriate date range, enter “Dallas” in the “Location Name” field, and click “Refine Search.” Under the “Sort” tab, radio buttons or other selectors may allow the user to sort the search results by, for example, newest, oldest, incident type, etc.

When the user conducts a search using the search query panel 1060, the search results may appear in a search results portion 1070 of the enterprise incidents page. The search results may appear in the search results portion 1070 as crime posting previews 1025. The crime posting previews 1025 may be the same as the crime posting previews 325 described in relation to the tipster UI 300 but with some differences in the information and functionality presented in view of the fact that the user browsing the crime posting previews 1025 is the registered crime poster 10 rather than a tipster 20. Thus, the information presented on the crime posting preview 1025 may include, for example, a summary of submitted tips and their respective tip statuses (e.g. “Tips: 2 Submitted, 0 Rejected, 0 Awarded”).

Similar to the “View Crime Details” button 326 of each crime posting preview 325, each the crime posting preview 1025 may have a “View Crime Details” button 1026, which may function as a link to a crime details page. In the case of the “View Crime Details” button 1026, the linked crime details page may be that of the crime details page of the crime poster UI 200 shown in FIG. 2. Also, similar to the crime posting previews 325, the crime posting previews 1025 may additionally have functionality to jump to functions of the crime details page without needing to first open up the crime details page for that crime posting. In the case of the crime posting previews 1025, such functionality may be, for example, a “Manage Crime” button 226 and a “Manage Tips” button 228 that may function just like their counterparts on the crime details page of FIG. 2. In this way, a user may, for example, quickly view any new anonymous tips associated with crimes of a particular business enterprise location, without having to open up each individual crime details page. In other respects, the search results portion 1070 may function similarly to the search results portion 370 of FIG. 6. A “download” button 1072 may also be provided for downloading all crime postings in the form of a list, table, or spreadsheet in a single document.

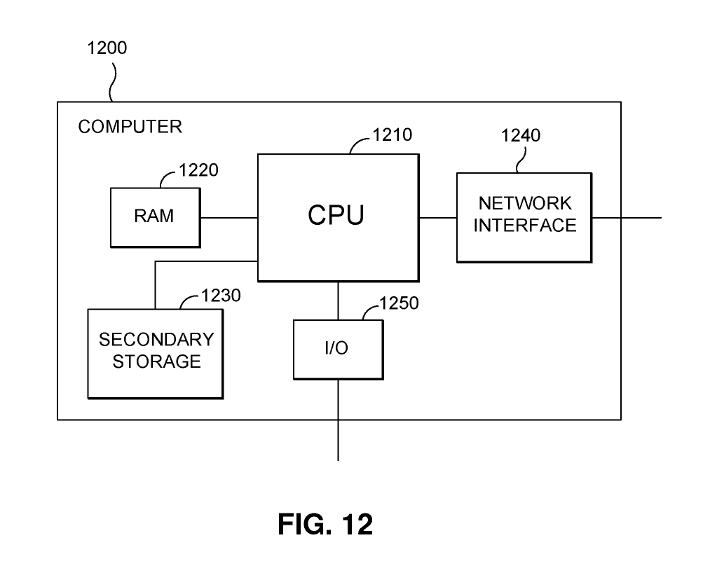

FIG. 12 shows an example of a computer 1200 in which the criminal investigation apparatus 100 of FIGS. 1 and 7, the operational flow of FIG. 9, and/or other embodiments of the disclosure may be wholly or partly embodied. The computer 1200, as shown in FIG. 12, may include a processor (CPU) 1210, a system memory (RAM) 1220 that temporarily stores results of data processing operations performed by the CPU 1210 and may be connected to the CPU 1210 by a dedicated memory channel, and a secondary storage device 1230 such as a hard drive. The CPU 1210 may execute one or more computer programs, which may be tangibly embodied in a computer-readable medium, e.g., the secondary storage device 1230, along with an operating system. The operating system and the computer programs may be loaded from the secondary storage device 1230 into the RAM 1220 for execution by the CPU 1210. A network interface 1240 may be provided for network communication (e.g. over the Internet) between the computer 1200 and external devices, such as devices of business entities 10, public users and/or law enforcement 30 accessing the various user interfaces described throughout this disclosure using a mobile application or web browser. Server-side user interaction with the computer 1200 may make use of one or more I/O devices 1250, such as a display, mouse, keyboard, etc.

The computer programs may comprise program instructions which, when executed by the CPU 1210, cause the CPU 1210 to perform operations in accordance with the various embodiments of the present disclosure. For example, a program that is installed in the computer 1200 may cause the computer 1200 to function as an apparatus such as the criminal investigation apparatus 100 of FIGS. 1 and 7, e.g., causing the computer 1200 to function as some or all of the sections, components, elements, databases, engines, interfaces, etc. of the apparatus 100 of FIG. 7 (e.g., the crime poster input interface 110, the criminal investigation engine 140, etc.). A program that is installed in the computer 1200 may also cause the computer 1200 to perform an operational flow such as the operational flow shown in FIG. 9 or a portion thereof, e.g., causing the computer 1200 to perform one or more of the steps of FIG. 9 (e.g., receive crime posting data from crime poster UI 912, update tipster UI to display new crime posting 916, etc.).

The above-mentioned program may be provided to the secondary storage 1230 by or otherwise reside on an external computer-readable medium such as a DVD-ROM, an optical recording medium such as a CD or Blu-ray Disk, a magneto-optic recording medium such as an MO, a tape medium, a semiconductor memory such as an IC card, a mechanically encoded medium such as a punch card, etc. Other examples of computer-readable media that may store programs in relation to the disclosed embodiments include a hard disk or RAM in a server system connected to a communication network such as a dedicated network or the Internet, such that the program may be provided to the computer 1200 via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

In the examples described with respect to FIGS. 1 and 7, a business entity 10 or other victim of a crime is assumed to be the crime poster, where the victim might be anyone from an individual homeowner to a large-scale business enterprise with many locations nationwide. However, the disclosure is not intended to be limited to this scenario. For example, it is also envisioned that a police department or other law enforcement 30 may serve as the crime poster and may submit crime postings to the criminal investigation apparatus 100 on behalf of victims who filed crime reports. In this case, the crime poster UI 200 and tip investigator UI 400 may be combined into a single user interface (as was also described above in the case where a victim crime poster 10 designates itself as a tip investigator). Along the same lines, it is contemplated that the criminal investigation apparatus 100 may be operated by a third-party service provider or by law enforcement 30 directly.

The various user interfaces described throughout this disclosure, including the crime poster UI 200, tipster UI 300, and tip investigator UI 400, are referred to as such only for ease of explanation. They do not necessarily demarcate boundaries of user interfaces more concretely than the boundaries of pages, screens, panels, portions, regions, etc. described herein. For example, an individual page such as the tip management page of the crime poster UI 200 may be regarded as a separate user interface from other pages of the crime poster UI 200. Along the same lines, the above-described input interfaces (e.g. the crime poster input interface 110, tipster input interface 120, and tip investigator input interface 130) do not necessarily refer to separable hardware or software elements and may merely define functional distinctions. For example, in a case where a crime poster designates him/herself as a tip investigator, a single hardware or software input interface may serve as both a crime poster input interface 110 and a tip investigator input interface 130.

Throughout the above descriptions of the crime poster UI 200, tipster UI 300, and tip investigator UI 400, reference is made to various means of user interaction, including clicks, touches, mouseovers, etc. The disclosure is not intended to be limited to such specific interactions and any known user-device interactions may be applicable, including but not limited to keyboard, mouse, touch, gesture, voice, eye-tracking, etc.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A non-transitory program storage medium on which are stored instructions executable by a processor or programmable circuit to perform operations for supporting a criminal investigation, the operations comprising:
receiving crime posting data generated by user interaction with a first user interface, the first user interface accessible via a web browser or mobile application;
updating a second user interface to display a new crime posting based on the crime posting data, the second user interface accessible via a web browser or mobile application;
receiving tip data generated by user interaction with the second user interface, the tip data including a reference to the new crime posting;
generating a unique tip identifier; and
storing the tip identifier in association with the tip data.

2. The non-transitory program storage medium of claim 1, wherein the operations further comprise:
updating a third user interface to display an anonymous tip based on the tip data, the third user interface accessible via a web browser or mobile application;
receiving tip status data generated by user interaction with the third user interface; and
storing the tip status data in association with the tip identifier.

3. The non-transitory program storage medium of claim 2, wherein the operations further comprise:
receiving a tip status request generated by user interaction with the second user interface, the tip status request including the tip identifier; and
updating the second user interface to display a tip status based on the tip status data stored in association with the tip identifier included in the tip status request.

4. The non-transitory program storage medium of claim 2, wherein the operations further comprise:
receiving a designation command generated by user interaction with the first user interface, the designation command designating a tip investigator associated with the crime posting data;
wherein access to the third user interface is limited to the tip investigator by secure login.

5. The non-transitory program storage medium of claim 1, wherein the second user interface includes a social media share button by which one or more content items of the new crime posting may be shared on social media by user interaction with the second user interface.

6. The non-transitory program storage medium of claim 5, wherein the first user interface displays social media interaction information in relation to the new crime posting.

7. The non-transitory program storage medium of claim 1, wherein the crime posting data includes location data and the second user interface includes an interactive map by which crime postings may be browsed by location.

8. The non-transitory program storage medium of claim 1, wherein the second user interface includes a search feature for viewing a subset of crime postings satisfying criteria specified by user interaction with the second user interface.

9. The non-transitory program storage medium of claim 8, wherein the second user interface displays, for each crime posting of the subset of crime postings, a summary including only a limited set of information about the crime posting, each of the summaries selectable by user interaction with the second user interface to allow viewing of a complete set of information about the crime posting.

10. The non-transitory program storage medium of claim 9, wherein, for each crime posting of the subset of crime postings, the second user interface includes a social media share button by which one or more content items of the crime posting may be shared on social media by user interaction with the second user interface, each of the social media share buttons being usable while the corresponding summary is displayed and the complete set of information about the corresponding crime posting is not displayed.

11. The non-transitory program storage medium of claim 9, wherein, for each crime posting of the subset of crime postings, the second user interface includes a view crime video button by which a crime video of the crime posting may be viewed by user interaction with the second user interface, each of the view crime video buttons being usable while the corresponding summary is displayed and the complete set of information about the corresponding crime posting is not displayed.

12. The non-transitory program storage medium of claim 1, wherein access to the first user interface is limited to a registered user by secure login.

13. The non-transitory program storage medium of claim 12, wherein the first user interface includes a list of locations associated with the registered user, each of the locations selectable by user interaction with the first user interface to allow viewing of a subset of crime postings associated with the location.

14. The non-transitory program storage medium of claim 1, wherein access to the second user interface is open to unregistered users.

15. A method of supporting a criminal investigation, the method comprising:
receiving crime posting data generated by user interaction with a first user interface, the first user interface accessible via a web browser or mobile application;
updating a second user interface to display a new crime posting based on the crime posting data, the second user interface accessible via a web browser or mobile application;
receiving tip data generated by user interaction with the second user interface, the tip data including a reference to the new crime posting;
generating a unique tip identifier; and
storing the tip identifier in association with the tip data.

16. The method of claim 15, further comprising:
updating a third user interface to display an anonymous tip based on the tip data, the third user interface accessible via a web browser or mobile application;
receiving tip status data generated by user interaction with the third user interface; and
storing the tip status data in association with the tip identifier.

17. The method of claim 16, further comprising:
receiving a tip status request generated by user interaction with the second user interface, the tip status request including the tip identifier; and
updating the second user interface to display a tip status based on the tip status data stored in association with the tip identifier included in the tip status request.

18. A system for supporting a criminal investigation, the system comprising:
a crime poster input interface for receiving crime posting data generated by user interaction with a first user interface, the first user interface accessible via a web browser or mobile application;
a server for updating a second user interface to display a new crime posting based on the crime posting data, the second user interface accessible via a web browser or mobile application; and
a tipster input interface for receiving tip data generated by user interaction with the second user interface, the tip data including a reference to the new crime posting;
wherein the server generates a unique tip identifier and stores the tip identifier in association with the tip data.

19. The system of claim 18, wherein
the server updates a third user interface to display an anonymous tip based on the tip data, the third user interface accessible via a web browser or mobile application;
the system further comprises a tip investigator input interface for receiving tip status data generated by user interaction with the third user interface; and
the server stores the tip status data in association with the tip identifier.

20. The system of claim 19, wherein the tipster input interface receives a tip status request generated by user interaction with the second user interface, the tip status request including the tip identifier, and updates the second user interface to display a tip status based on the tip status data stored in association with the tip identifier included in the tip status request.
